(19) United States
(12) Patent Application Publication
(10) Pub. No.: US 2025/0296590 A1
(43) Pub. Date: Sep. 25, 2025

(54) INFORMATION PROCESSING DEVICE, INFORMATION PROCESSING METHOD, AND RECORDING MEDIUM

(71) Applicant: Panasonic Automotive Systems Co., Ltd., Kanagawa (JP)

(72) Inventors: Takayuki SUZUKI, Kanagawa Ken (JP); Akitoshi YAMASHITA, Hyogo Ken (JP); Tetsuo NAKAMURA, Shiga Ken (JP); Toshiki IWAHANA, Kyoto Fu (JP)

(73) Assignee: Panasonic Automotive Systems Co., Ltd., Kanagawa (JP)

(21) Appl. No.: 19/011,124

(22) Filed: Jan. 6, 2025

(30) Foreign Application Priority Data
Mar. 25, 2024 (JP) 2024-047568

(51) Int. Cl. B60W 50/14; G06V 20/56; G06V 20/58

(52) U.S. Cl. CPC B60W 50/14; G06V 20/58; G06V 20/588

(57) ABSTRACT

An information processing device includes a memory and a processor coupled to the memory. In the memory, a computer program is stored. The processor performs processing by executing the computer program. The processing includes determining whether another vehicle captured in a captured image of a periphery of an own vehicle is a two-wheel vehicle or a four-wheel vehicle. The processing also includes outputting warning information based on an output condition corresponding to a result of the determination.

### CROSS-REFERENCE TO RELATED APPLICATIONS

This application is based upon and claims the benefit of priority from Japanese Patent Application No. 2024-047568, filed on Mar. 25, 2024, the entire contents of which are incorporated herein by reference.

### FIELD

The present disclosure relates to an information processing device, an information processing method, and a recording medium.

### BACKGROUND

In the related art, introduction of a warning function to notify a driver of another vehicle approaching an own vehicle has progressed.

For example, patent literatures JP-A-2022-151314, WO 2016/147584, etc. disclose a function to determine whether or not a distance to the detected other vehicle is a warning output threshold or less to determine whether or not the warning is necessary, or a function to change the threshold of the distance for outputting the warning based on determination as to whether the detected vehicle is a two-wheel vehicle.

In the related art, however, there is a case that warning information is output even in a situation where warning is unnecessary, and there is a case that appropriate warning information corresponding to another vehicle around an own vehicle is not output.

Therefore, it is desired to perform output of appropriate warning information corresponding to another vehicle around an own vehicle.

### SUMMARY

An information processing device according to one aspect of the present disclosure includes a memory and a processor coupled to the memory. In the memory, a computer program is stored. The processor is configured to perform processing by executing the computer program. The processing includes determining whether another vehicle captured in a captured image of a periphery of an own vehicle is a two-wheel vehicle or a four-wheel vehicle, and outputting warning information based on an output condition corresponding to a result of the determination.

### BRIEF DESCRIPTION OF THE DRAWINGS

FIG. 1 is a schematic diagram illustrating an example of a utility form of an information processing device according to an embodiment;

FIG. 2 is a block diagram illustrating an example of a functional configuration of an own vehicle;

FIG. 3 is a hardware configuration diagram illustrating an example of the information processing device;

FIG. 4 is a schematic diagram illustrating an example of a positional relationship between the own vehicle and another vehicle;

FIG. 5A is a schematic diagram illustrating an example of warning information regarding a two-wheel vehicle displayed on a display unit;

FIG. 5B is a schematic diagram illustrating an example of the warning information regarding the two-wheel vehicle displayed on the display unit;

FIG. 6A is a schematic diagram illustrating an example of warning information regarding a four-wheel vehicle displayed on the display unit;

FIG. 6B is a schematic diagram illustrating an example of the warning information regarding the four-wheel vehicle displayed on the display unit;

FIG. 6C is a schematic diagram illustrating an example of the warning information regarding the four-wheel vehicle displayed on the display unit; and

FIG. 7 is a flowchart illustrating an example of a procedure of information processing that is executed by the information processing device according to the embodiment.

### DETAILED DESCRIPTION

Hereinafter, an embodiment of an information processing device, an information processing method, and a recording medium according to the present disclosure will be described with reference to the accompanying drawings.

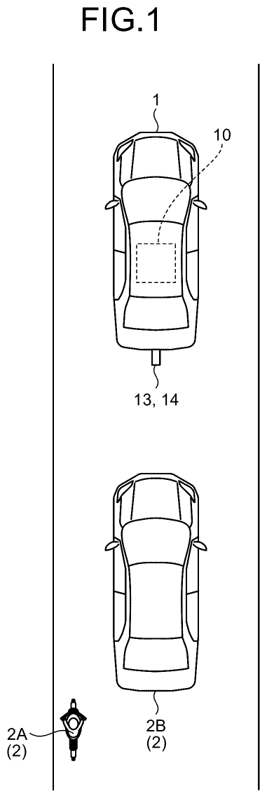

FIG. 1 is a schematic diagram illustrating an example of a utility form of an information processing device 10 according to the present embodiment.

The information processing device 10 is a device for warning the presence of other vehicle 2 around an own vehicle 1 to a passenger of the own vehicle 1. In the present embodiment, a form where the information processing device 10 is mounted on the own vehicle 1 will be described as an example.

The own vehicle 1 is a vehicle on which the information processing device 10 is mounted. The other vehicle 2 is a vehicle other than the vehicle on which the information processing device 10 is mounted.

In the present embodiment, based on an output condition corresponding to a result of determination on whether the other vehicle 2 around the own vehicle 1 is a two-wheel vehicle 2A or a four-wheel vehicle 2B, the information processing device 10 outputs warning information regarding the determined other vehicle 2 to the passenger of the own vehicle 1 (the details will be described below).

The two-wheel vehicle 2A is a vehicle including two wheels. The two-wheel vehicle 2A is, for example, a motorcycle, a scooter, a motorized bicycle, a bicycle, or an electric kick scooter. The four-wheel vehicle 2B is a vehicle including four or more wheels. The four-wheel vehicle 2B is, for example, an ordinary-sized automobile, a small-sized automobile, a mid-sized automobile, a large-sized automobile, a mini automobile, or a special automobile.

Next, a functional configuration of the own vehicle 1 will be described in detail.

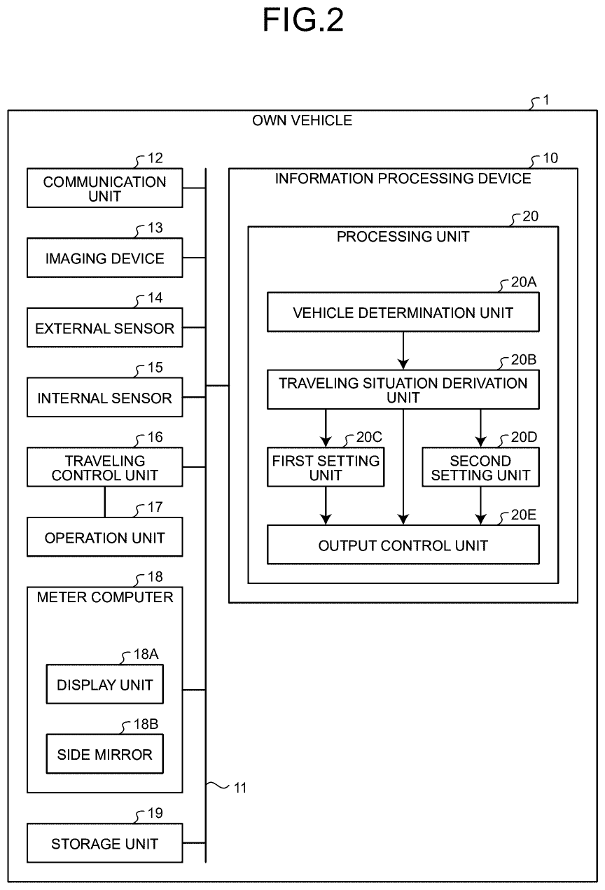

FIG. 2 is a block diagram illustrating an example of the functional configuration of the own vehicle 1.

The own vehicle 1 includes a communication unit 12, an imaging device 13, an external sensor 14, an internal sensor 15, a traveling control unit 16, an operation unit 17, a meter computer 18, a storage unit 19, and the information processing device 10.

The communication unit 12, the imaging device 13, the external sensor 14, the internal sensor 15, the traveling control unit 16, the operation unit 17, the meter computer 18, the storage unit 19, and the information processing device 10 are communicably connected to each other through a bus 11 or the like. As the bus 11, for example, a local area network such as CAN (Controller Area Network) may be used.

The communication unit 12 is a communication interface that communicates with an external device. The communication unit 12 communicates with an external information processing device, for example, through a network or the like. In addition, the communication unit 12 may communicate with the other vehicle 2 through inter-vehicle communication or the like. As the inter-vehicle communication, for example, V2V (Vehicle to Vehicle) is used.

The imaging device 13 images the periphery of the own vehicle 1 to obtain captured image data. Hereinafter, the captured image data will be simply referred as the captured image. In the present embodiment, the imaging device 13 continuously executes imaging in chronological order, and sequentially outputs the captured images obtained by imaging to the information processing device 10.

In the present embodiment, a form where the imaging device 13 that images at least the rear side of the own vehicle 1 as an imaging region is provided in the own vehicle 1 will be described. For example, as illustrated in FIG. 1, in the imaging device 13, an imaging angle of view, an installation position, and the like are previously adjusted such that the other vehicle 2 present on at least the rear side in the periphery of the own vehicle 1 can be imaged. The imaging device 13 outputs the captured images obtained by imaging the rear side in the periphery of the own vehicle 1 to the information processing device 10. The imaging device 13 may be previously adjusted such that at least the rear side of the own vehicle 1 can be imaged, or the number of the imaging devices 13 provided in the own vehicle 1 and the installation positions thereof are not limited.

Referring back to FIG. 2, the description continues.

The external sensor 14 is mounted on the own vehicle 1 and detects an external situation of the own vehicle 1. In the present embodiment, the external sensor 14 detects whether or not the other vehicle 2 is present, the distance to the other vehicle 2, and the like. The external sensor 14 is, for example, a distance sensor, a sonar sensor for detecting an object using sonic waves, or an ultrasonic sensor. The distance sensor is, for example, a millimeter wave radar or a laser sensor. The laser sensor is, for example, a two-dimensional LiDAR (Laser Imaging Detection and Ranging) sensor that is provided parallel to a horizontal plane or a three-dimensional LiDAR sensor. As illustrated in FIG. 1, in the present embodiment, the external sensor 14 is disposed at a position where the other vehicle 2 present on at least the rear side of the own vehicle 1 can be detected. The external sensor 14 may be previously adjusted such that the other vehicle 2 on at least the rear side of the own vehicle 1 can be detected, or the number of the external sensors 14 provided in the own vehicle 1 and the installation positions thereof are not limited.

Referring back to FIG. 2, the description continues.

The internal sensor 15 is a sensor that detects the state of the own vehicle 1. The internal sensor 15 detects a position of the own vehicle 1, a speed, an acceleration, an accelerator position, a steering angle of a steering device, an amount of depression of a brake pedal, and the like. The internal sensor 15 includes, for example, GPS (Global Positioning System), a speed sensor, an acceleration sensor such as an IMU (Inertial Measurement Unit) that detects at least an acceleration in a front-rear direction of the own vehicle 1, an accelerator position sensor that detects the accelerator position, a steering angle sensor that detects the steering angle of the steering device, and a sensor that detects the amount of depression of the brake pedal.

The traveling control unit 16 is an ECU (Engine Control Unit) that controls the traveling of the own vehicle 1. The traveling control unit 16 executes a control of a drive device such as an engine, a motor, or the like of the own vehicle 1 and a control of a transmission system device such as a transmission of the own vehicle 1, in accordance with operation information of the passenger received from the operation unit 17 or the detection result of the internal sensor 15.

The operation unit 17 is operated by the passenger of the own vehicle 1. The operation unit 17 includes, for example, an ignition switch, a shift lever, a steering, a direction indicator, an accelerator pedal, and a brake pedal. The direction indicator is an indicator for notifying the periphery of a change of a moving direction of the own vehicle 1. The operation unit 17 mounted on the own vehicle 1 is not limited to these examples.

The traveling control unit 16 controls the drive device and the transmission system device of the own vehicle 1 in accordance with operation information of the ignition switch, shift position information of the shift lever, operation information of the direction indicator, a steering angle represented by the amount of steering operation, accelerator pedal operation information of the accelerator pedal, brake pedal information of the brake pedal, and the like. In addition, in the present embodiment, the traveling control unit 16 outputs the operation information of the direction indicator and the like to the information processing device 10.

The meter computer 18 has an information notification function to the passenger such as a driver. The meter computer 18 is, for example, an HMI (human machine interface). The information notification function is a display function to display information, a sound output function to output a sound representing information, a light output function to blink or turn on light representing information, or the like. The display function is, for example, a combination meter device that notifies information to the driver by displaying. The sound output function is, for example, a notification sound generation device such as a boozer or a speaker that uses a voice for notification.

In the present embodiment, a form where the meter computer 18 includes at least a display unit 18A and a side mirror 18B will be described as an example.

The display unit 18A is a device that displays information. In the present embodiment, a form where the display unit 18A is an electron mirror will be described as an example. The electron mirror is a device that projects the captured image of the rear side of the own vehicle 1 to a mirror surface. Depending on the manufacturer or the like of the own vehicle 1, the electron mirror may also be referred to as a smart rear view mirror (SRVM), a smart room mirror, an intelligent room mirror, an electron inner mirror, or the like.

In the side mirror 18B, an indicator is provided, and the indicator of the side mirror 18B functions as a device for outputting various information. The side mirror 18B may be configured as an electron side mirror that displays captured images of the lateral side of the own vehicle 1. In this case, the side mirror 18B functions as a device that outputs information. In the present embodiment, a form where the indicator of the side mirror 18B functions as a device for outputting various information will be described as an example.

The storage unit 19 stores various data. At least some pieces of the data in the storage unit 19 may be stored in an external storage device communicably connected to the information processing device 10.

Next, the information processing device 10 will be described in detail.

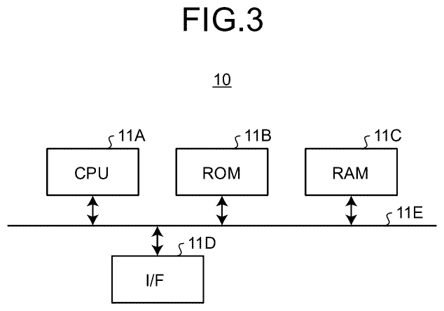

FIG. 3 is a hardware configuration diagram illustrating an example of the information processing device 10.

The information processing device 10 has a hardware configuration using a typical computer where a CPU (Central Processing Unit) 11A, a ROM (Read Only Memory) 11B, a RAM (Random Access Memory) 11C, an I/F (Interface) 11D, and the like are connected to each other through a bus 11E.

The CPU 11A is an arithmetic device that controls the information processing device 10 according to the present embodiment. The ROM 11B stores a program or the like for allowing the CPU 11A to implement various processes. The RAM 11C stores data required for the CPU 11A to implement various processes. The I/F 11D is an interface for transmitting and receiving data.

The program for executing information processing that is executed by the information processing device 10 according to the present embodiment is previously incorporated into the ROM 11B or the like and provided. The program that is executed by the information processing device 10 according to the present embodiment may be configured to be provided in a state where the program is recorded in a computer-readable recording medium such as a CD-ROM, a flexible disk (FD), a CD-R, or a DVD (Digital Versatile Disc) as a file in a format that is installable or executable in the information processing device 10.

Referring back to FIG. 2, the description continues.

The information processing device 10 includes a processing unit 20. The processing unit 20 executes various information processing. For example, the CPU 11A reads the program from the ROM 11B to the RAM 11C and executes the read program such that each of the functional units described below of the processing unit 20 is implemented on the computer.

The processing unit 20 includes a vehicle determination unit 20A, a traveling situation derivation unit 20B, a first setting unit 20C, a second setting unit 20D, and an output control unit 20E. For example, some or all of the vehicle determination unit 20A, the traveling situation derivation unit 20B, the first setting unit 20C, the second setting unit 20D, and the output control unit 20E may be implemented, for example, by allowing the processing device such as the CPU 11A to execute the program, namely, by software, may be implemented by hardware such as an IC (Integrated Circuit), or may be implemented by a combination of software and hardware. In addition, at least one of the vehicle determination unit 20A, the traveling situation derivation unit 20B, the first setting unit 20C, the second setting unit 20D, and the output control unit 20E may be configured to be mounted on an external information processing device that is communicably connected to the information processing device 10 through a network or the like.

The vehicle determination unit 20A determines whether the other vehicle 2 in the captured image of the periphery of the own vehicle 1 is the two-wheel vehicle 2A or the four-wheel vehicle 2B. The vehicle determination unit 20A identifies the other vehicle 2 in the captured image by analyzing the captured image obtained by the imaging device 13 with a well-known method using pattern matching, an AI (Artificial Intelligence) trained by Deep Learning or the like, or the like, and determines whether the identified other vehicle 2 is the two-wheel vehicle 2A or the four-wheel vehicle 2B. When the vehicle determination unit 20A detects an object other than the two-wheel vehicle 2A and the four-wheel vehicle 2B in the captured image, the vehicle determination unit 20A does not perform determination regarding the object. That is, in the present embodiment, the vehicle determination unit 20A determines only at least one of the two-wheel vehicle 2A and the four-wheel vehicle 2B in the captured image.

The traveling situation derivation unit 20B derives traveling situation information regarding a traveling situation of at least one of the own vehicle 1 and the other vehicle 2 determined by the vehicle determination unit 20A. The traveling situation information includes first traveling situation information, second traveling situation information, and relative traveling situation information.

For example, a case where the vehicle determination unit 20A determines that the other vehicle 2 in the captured image is the two-wheel vehicle 2A is assumed. In this case, the traveling situation derivation unit 20B derives the first traveling situation information. In addition, for example, a case where the vehicle determination unit 20A determines that the other vehicle 2 in the captured image is the four-wheel vehicle 2B is assumed. In this case, the traveling situation derivation unit 20B derives the second traveling situation information.

First, the first traveling situation information will be described. The first traveling situation information is information regarding the traveling situation of at least one of the own vehicle 1 and the determined two-wheel vehicle 2A. In other words, the first traveling situation information includes information representing the traveling situation of each of the own vehicle 1 and the two-wheel vehicle 2A present on the rear side of the own vehicle 1 and a relative traveling situation between the own vehicle 1 and the two-wheel vehicle 2A.

Specifically, for example, the first traveling situation information is information representing at least one of a vehicle speed of the own vehicle 1, the number of times of changing a traveling direction of the two-wheel vehicle 2A, an illuminance of a traveling environment of the own vehicle 1 and the two-wheel vehicle 2A, a driving skill of the driver of the own vehicle 1, an estimated size of the two-wheel vehicle 2A, a color difference between the color of the two-wheel vehicle 2A and the color of a traveling road surface of the two-wheel vehicle 2A, a type of a traveling road where the own vehicle 1 and the two-wheel vehicle 2A are traveling, an estimated crash severity during crash of the two-wheel vehicle 2A with another object, whether or not the current traveling site of the own vehicle 1 and the two-wheel vehicle 2A is in a warning target region, whether or not an environment of a traveling road surface of the own vehicle 1 and the two-wheel vehicle 2A is a predetermined vehicle rollover risk environment, a steering angle of the own vehicle 1, a situation of acceleration and deceleration of the own vehicle 1, an area including a traveling region where the own vehicle 1 and the two-wheel vehicle 2A are traveling, a vehicle type of the two-wheel vehicle 2A, and an operation of the passenger of the two-wheel vehicle 2A.

The vehicle speed of the own vehicle 1 refers to the current vehicle speed of the own vehicle 1. The traveling situation derivation unit 20B determines the vehicle speed of the own vehicle 1 by acquiring the vehicle speed of the own vehicle 1 detected by the internal sensor 15. The traveling situation derivation unit 20B may determine the vehicle speed of the own vehicle 1 by acquiring the vehicle speed of the own vehicle 1 from the traveling control unit 16 through a CAN or the like.

The number of changes in traveling refers to the number of changes from a state where the two-wheel vehicle 2A determined by the vehicle determination unit 20A is seen from the passenger of the own vehicle 1 to a state where the two-wheel vehicle 2A is hidden by the other vehicle 2 present between the two-wheel vehicle 2A and the own vehicle 1. By analyzing the captured image of the rear side of the own vehicle 1 obtained by the imaging device 13, the traveling situation derivation unit 20B counts the number of repetitions of a series of states, in which the number is counted once when the series of states including a state where at least part of the two-wheel vehicle 2A is exposed from the other vehicle 2 in the captured image and a state where the entirety of the two-wheel vehicle 2A is captured in the captured image occurs once. The traveling situation derivation unit 20B determines the count value of the number of repetitions as the number of changes in traveling of the two-wheel vehicle 2A.

In addition, the number of changes in traveling may refer to the number of changes in traveling per unit time of the two-wheel vehicle 2A to a direction intersecting with an advancing direction of the own vehicle 1. In this case, by analyzing the captured image of the rear side obtained by the imaging device 13, the traveling situation derivation unit 20B determines the number of changes in traveling representing the number of changes in traveling per unit time of the two-wheel vehicle 2A in the captured image to the direction intersecting with the advancing direction of the own vehicle 1, the two-wheel vehicle 2A being determined by the vehicle determination unit 20A. In this case, the number of changes in traveling refers to the number of reciprocating movements, in which the number is counted once when the reciprocating movement where the two-wheel vehicle 2A moves in one direction and subsequently moves in another direction with respect to the direction intersecting with the advancing direction of the own vehicle 1 occurs once. The reciprocating movement of the two-wheel vehicle 2A with respect to the own vehicle 1 will also be referred to as zigzag driving or the like.

The illuminance of the traveling environment of the own vehicle 1 and the two-wheel vehicle 2A refers to the illuminance of the environment where the own vehicle 1 and the two-wheel vehicle 2A are traveling. Regarding the illuminance of the environment, for example, the value in night time is lower than that in the day time, and the value in rainy or cloudy weather is lower than that in sunny weather. For example, in a configuration where an illuminance sensor is further provided in the external sensor 14, the traveling situation derivation unit 20B determines the illuminance of the traveling environment by acquiring the illuminance detected by the illuminance sensor. In addition, the traveling situation derivation unit 20B may estimate the illuminance of the traveling environment by estimating a scene such as daytime, twilight, or night time from the captured image using an AI trained by Deep Learning or the like.

In addition, the traveling situation derivation unit 20B may acquire a weather of an environment in a site where the own vehicle 1 and the two-wheel vehicle 2A are traveling through the communication unit 12 from an external server device that distributes weather information to acquire an illuminance represented by the weather. For example, the traveling situation derivation unit 20B may acquire the illuminance by previously registering weather information and illuminance information in the storage unit 19 in association with each other and reading the illuminance information corresponding to the weather information received from the server device. In addition, the traveling situation derivation unit 20B may determine the illuminance of the traveling environment by detecting the current time. For example, the traveling situation derivation unit 20B previously stores, in the storage unit 19, a correspondence between time information and illuminance information representing the illuminance of the traveling environment. In the storage unit 19, illuminance information representing an illuminance lower than an illuminance corresponding to time information representing a period of time of the day time may be previously stored in association with time information representing a period of time of the night time. The traveling situation derivation unit 20B may determine the illuminance of the traveling environment of the own vehicle 1 and the two-wheel vehicle 2A by reading the illuminance information corresponding to the time information of the current time from the storage unit 19.

The driving skill of the driver of the own vehicle 1 is information representing the driving skill of the driver who drives the own vehicle 1. The driving skill is represented by, for example, the driving record of the driver, the age of the driver, and the like. For example, in the storage unit 19, driving skill information representing a numerical value of the driving skill that becomes higher as the driving record of the driver increases and that becomes lower as the age of the driver increases is previously stored in response to an operation instruction of the operation unit 17 by the driver. The traveling situation derivation unit 20B determines the driving skill of the driver of the own vehicle 1 by reading the driving skill information from the storage unit 19. In addition, the traveling situation derivation unit 20B may estimate the driving skill of the driver with a well-known method using a captured image obtained by the imaging device that is provided in the own vehicle 1 to image the driver and information representing an accelerator control of the driver obtained by the internal sensor 15 or the traveling control unit 16.

The estimated size of the two-wheel vehicle 2A is information regarding the estimated size of the two-wheel vehicle 2A in a real space. By analyzing the two-wheel vehicle 2A in the captured image using a well-known method, the traveling situation derivation unit 20B estimates the size of the two-wheel vehicle 2A in the real space to determine the estimated size. For example, the traveling situation derivation unit 20B estimates the size of the two-wheel vehicle 2A using a region of the two-wheel vehicle 2A in the captured image and an inter-vehicle distance between the own vehicle 1 and the two-wheel vehicle 2A. In addition, the traveling situation derivation unit 20B may determine the estimated size of the two-wheel vehicle 2A by identifying the vehicle type of the two-wheel vehicle 2A in the captured image and acquiring size information corresponding to the identified vehicle type from the storage unit 19 or an external information processing device.

The color difference between the two-wheel vehicle 2A and the traveling road surface is a color difference between the color of the two-wheel vehicle 2A and the color of the road surface where the two-wheel vehicle 2A is traveling. For example, by analyzing the captured image obtained by the imaging device 13, the traveling situation derivation unit 20B determines, as the color difference, a difference between an average value of pixel values in an image region of the two-wheel vehicle 2A and an average value of pixel values in a traveling road surface region including at least a region in contact with a wheel of the two-wheel vehicle 2A.

The type of the traveling road where the own vehicle 1 and the two-wheel vehicle 2A are traveling is whether the traveling road where the own vehicle 1 and the two-wheel vehicle 2A are traveling is a highway or a general road. The highway is a road where high-speed traveling at a predetermined speed or higher is allowed. The traveling situation derivation unit 20B identifies the type of the traveling road where the own vehicle 1 and the two-wheel vehicle 2A are traveling by identifying the type of the road present at the current position of the own vehicle 1 in map data that is used in a car navigation system mounted on the own vehicle 1. In addition, the traveling situation derivation unit 20B may identify the type of the traveling road by analyzing the captured image.

The estimated crash severity during crash of the two-wheel vehicle 2A with another object is information representing an estimated value of the severity when the two-wheel vehicle 2A that is traveling crashes with another object. The estimated crash severity is represented by, for example, kinetic energy. The traveling situation derivation unit 20B identifies, for example, the type of the two-wheel vehicle 2A by analyzing the captured image. The type of the two-wheel vehicle 2A is represented by a vehicle type, a manufacturer name, a model, and the like of the two-wheel vehicle 2A. The traveling situation derivation unit 20B acquires the mass of the two-wheel vehicle 2A of the identified type from the storage unit 19 or an external information processing device, and calculates, as the estimated crash severity of the two-wheel vehicle 2A, the kinetic energy from the mass×the square of the current speed of the two-wheel vehicle 2A×½. The traveling situation derivation unit 20B may acquire the speed of the two-wheel vehicle 2A by analyzing the captured image using a well-known method. In addition, the traveling situation derivation unit 20B may acquire the speed and the mass of the two-wheel vehicle 2A from the two-wheel vehicle 2A by inter-vehicle communication (V2V) or the like through the communication unit 12.

The warning target region is a predetermined target region for which warning information is output to the passenger of the own vehicle 1 in a real space. The warning target region is, for example, an intersection or a junction of a highway. For example, the warning target region may be previously registered in the map data in response to an operation instruction of the operation unit 17 by a user. The traveling situation derivation unit 20B may determine whether or not the current traveling site of the own vehicle 1 and the two-wheel vehicle 2A is in the warning target region registered in the map data. The traveling situation derivation unit 20B may use the position of the own vehicle 1 detected by the internal sensor 15 as the current traveling site of the own vehicle 1 and the two-wheel vehicle 2A.

The information representing the vehicle rollover risk environment is information representing that the traveling road surface of the own vehicle 1 and the two-wheel vehicle 2A is an environment where the two-wheel vehicle 2A is likely to roll over. Specifically, the information representing the vehicle rollover risk environment is represented by information representing a road surface environment such as freezing, rainy weather, or snow accumulation. The information representing the vehicle rollover risk environment may be preset and previously stored in the storage unit 19 or the like. The traveling situation derivation unit 20B acquires information representing a road surface situation of a traveling road surface at the current position of the own vehicle 1, for example, from a weather server or an information processing device for providing the road surface situation, and determines whether or not the information is information that matches with the vehicle rollover risk environment to determine whether or not the environment of the traveling road surface of the own vehicle 1 and the two-wheel vehicle 2A is a predetermined vehicle rollover risk environment. In addition, by analyzing an image region of the traveling road surface in the captured image using a known method, the traveling situation derivation unit 20B may determine information representing the road surface situation of the traveling road surface. The traveling situation derivation unit 20B may determine whether or not the information is information that matches with the vehicle rollover risk environment to determine whether or not the environment of the traveling road surface of the own vehicle 1 and the two-wheel vehicle 2A is a predetermined vehicle rollover risk environment.

The steering angle of the own vehicle 1 is the current steering angle of the own vehicle 1. The traveling situation derivation unit 20B determines the steering angle of the own vehicle 1 by acquiring the steering angle of the steering device detected by the internal sensor 15.

The situation of acceleration and deceleration of the own vehicle 1 is information representing whether the own vehicle 1 is accelerating or decelerating and the acceleration in this case. The traveling situation derivation unit 20B acquires the acceleration detected by the internal sensor 15 and, when the acquired acceleration is a negative value, determines that the own vehicle 1 is decelerating. In addition, the traveling situation derivation unit 20B determines the acceleration at this time as an acceleration during deceleration. In addition, the traveling situation derivation unit 20B may determine the acceleration in the deceleration direction of the own vehicle 1 from the amount of depression of the brake pedal detected by the internal sensor 15.

The area including the traveling region where the own vehicle 1 and the two-wheel vehicle 2A are traveling is a country or an area where the own vehicle 1 and the two-wheel vehicle 2A are traveling. The traveling situation derivation unit 20B determines the area including the traveling region where the own vehicle 1 and the two-wheel vehicle 2A are traveling, by locating the position in the map data corresponding to the position of the own vehicle 1 detected by the internal sensor 15.

The vehicle type of the two-wheel vehicle 2A is a label of each of classifications when the two-wheel vehicle 2A is classified according to a predetermined rule. In the present embodiment, the vehicle type of the two-wheel vehicle 2A represents whether or not the two-wheel vehicle 2A is a warning target vehicle. The warning target vehicle of the two-wheel vehicle 2A is a vehicle of the vehicle type that is a target of warning to the own vehicle 1. The warning target vehicle is a vehicle that is designated and allowed for preferential passing in the road or preferential use of the road. Specifically, the warning target vehicle of the two-wheel vehicle 2A is, for example, a motorcycle attached with various devices required for traffic control work by the police but is not limited thereto. The vehicle type belonging to the warning target vehicle may be previously registered in the storage unit 19 in response to, for example, an operation instruction of the operation unit 17 by the passenger or the like of the own vehicle 1. By analyzing the captured image, the traveling situation derivation unit 20B may identify the vehicle type of the two-wheel vehicle 2A in the captured image to determine whether or not the vehicle type is the warning target vehicle.

The operation of the passenger of the two-wheel vehicle 2A represents a behavior such as a gesture of at least either one of the driver that is on board the two-wheel vehicle 2A and a fellow passenger that is on board the two-wheel vehicle 2A together with the driver. By analyzing the captured image using a well-known method, the traveling situation derivation unit 20B determines the behavior of passenger of the two-wheel vehicle 2A in the captured image.

Next, the second traveling situation information will be described. As described above, a case where the vehicle determination unit 20A determines that the other vehicle 2 in the captured image is the four-wheel vehicle 2B is assumed. In this case, the traveling situation derivation unit 20B derives the second traveling situation information.

The second traveling situation information is information regarding the traveling situation of at least either one of the own vehicle 1 and the determined four-wheel vehicle 2B. In other words, the second traveling situation information includes information representing the traveling situation of each of the own vehicle 1 and the four-wheel vehicle 2B present on the rear side of the own vehicle 1 and a relative traveling situation between the own vehicle 1 and the four-wheel vehicle 2B.

Specifically, for example, the second traveling situation information is information representing at least one of a vehicle speed of the own vehicle 1, an estimated size of the four-wheel vehicle 2B, a type of a traveling road where the own vehicle 1 and the four-wheel vehicle 2B are traveling, an estimated crash severity during crash of the four-wheel vehicle 2B with another object, whether or not the current traveling site of the own vehicle 1 and the four-wheel vehicle 2B is in a warning target region, a vehicle registration number of the four-wheel vehicle 2B, an area including a traveling region where the own vehicle 1 and the four-wheel vehicle 2B are traveling, and a vehicle type of the four-wheel vehicle 2B.

The vehicle speed of the own vehicle 1 is the current vehicle speed of the own vehicle 1 as described above.

The estimated size of the four-wheel vehicle 2B is information regarding the estimated size of the four-wheel vehicle 2B in a real space. By analyzing the four-wheel vehicle 2B in the captured image using a well-known method, the traveling situation derivation unit 20B estimates the size of the four-wheel vehicle 2B in the real space to determine the estimated size. For example, the traveling situation derivation unit 20B estimates the size of four-wheel vehicle 2B using a region of the four-wheel vehicle 2B in the captured image and an inter-vehicle distance between the own vehicle 1 and the four-wheel vehicle 2B. In addition, the traveling situation derivation unit 20B may determine the estimated size of the four-wheel vehicle 2B by identify the vehicle type of the four-wheel vehicle 2B in the captured image and acquiring size information corresponding to the identified vehicle type from the storage unit 19 or an external information processing device.

The type of the traveling road where the own vehicle 1 and the four-wheel vehicle 2B are traveling is whether the traveling road where the own vehicle 1 and the four-wheel vehicle 2B are traveling is a highway or a general road. The traveling situation derivation unit 20B may determine the type of the traveling road of the own vehicle 1 and the four-wheel vehicle 2B using the same method as the method of determining the type of the traveling road of the own vehicle 1 and the two-wheel vehicle 2A.

The estimated crash severity during crash of the four-wheel vehicle 2B with another object is information representing an estimated value of the severity when the four-wheel vehicle 2B that is traveling collides with another object. As described above, the estimated crash severity is represented by, for example, kinetic energy. The traveling situation derivation unit 20B determines, for example, the type of the four-wheel vehicle 2B by analyzing the captured image. The type of the four-wheel vehicle 2B is represented by the classification of the vehicle such as small-sized vehicle, an ordinary-sized vehicle, or a large-sized vehicle, a manufacturer name, a model, or the like. The traveling situation derivation unit 20B acquires the mass of the four-wheel vehicle 2B of the determined type from the storage unit 19 or an external information processing device, and calculates, as the estimated crash severity of the four-wheel vehicle 2B, the kinetic energy from the mass×the square of the current speed of the four-wheel vehicle 2B×½. The traveling situation derivation unit 20B may acquire the speed of the four-wheel vehicle 2B by analyzing the captured image using a well-known method. In addition, the traveling situation derivation unit 20B may acquire the speed and the mass of the four-wheel vehicle 2B from the four-wheel vehicle 2B by inter-vehicle communication (V2V) or the like through the communication unit 12.

The warning target region is the same as that described above regarding the two-wheel vehicle 2A. The traveling situation derivation unit 20B may determine whether or not the current traveling site of the own vehicle 1 and the four-wheel vehicle 2B is in the warning target region registered in the map data. The traveling situation derivation unit 20B may use the position of the own vehicle 1 detected by the internal sensor 15 as the current traveling site of the own vehicle 1 and the four-wheel vehicle 2B.

The vehicle registration number is a number used for uniquely identifying the four-wheel vehicle 2B. The vehicle registration number is represented by characters such as numerical values attached to a license plate of the four-wheel vehicle 2B. The traveling situation derivation unit 20B may determine the vehicle registration number of the four-wheel vehicle 2B by analyzing characters in a region of the license plate of the four-wheel vehicle 2B in the captured image using a well-known character recognition method or the like.

The area including the traveling region where the own vehicle 1 and the four-wheel vehicle 2B are traveling is a country or an area where the own vehicle 1 and the four-wheel vehicle 2B are traveling. The traveling situation derivation unit 20B determines the area including the traveling region where the own vehicle 1 and the four-wheel vehicle 2B are traveling by locating the position in the map data corresponding to the position of the own vehicle 1 detected by the internal sensor 15.

The vehicle type of the four-wheel vehicle 2B is a label of each of classifications when the four-wheel vehicle 2B is classified according to a predetermined rule. In the present embodiment, the vehicle type of the four-wheel vehicle 2B represents whether or not the four-wheel vehicle 2B is a warning target vehicle. The warning target vehicle of the four-wheel vehicle 2B is a vehicle of the vehicle type that is a target of warning to the own vehicle 1. The warning target vehicle of the four-wheel vehicle 2B is a vehicle that is designated and allowed for preferential passing in the road or preferential use of the road. Specifically, the warning target vehicle of the four-wheel vehicle 2B is, for example, a large-sized vehicle or a special vehicle such as a police vehicle, an emergency vehicle, a fire vehicle, a bus, a taxi, or a truck. The vehicle type belonging to the warning target vehicle of the four-wheel vehicle 2B may be previously registered in the storage unit 19 in response to, for example, an operation instruction of the operation unit 17 by the passenger or the like of the own vehicle 1. By analyzing the captured image, the traveling situation derivation unit 20B may identify the vehicle type of the four-wheel vehicle 2B in the captured image to determine whether or not the vehicle type is the warning target vehicle.

Next, the relative traveling situation information will be described.

The relative traveling situation information is information representing a relative traveling situation between the own vehicle 1 and the other vehicle 2 determined by the vehicle determination unit 20A. Specifically, the relative traveling situation information is information representing an inter-vehicle distance between the own vehicle 1 and the other vehicle 2, a lane on which each of the own vehicle 1 and the other vehicle 2 is traveling, another lane that is a lane around the own vehicle 1 and where the own vehicle 1 is allowed to travel in the same direction as the traveling direction of the current traveling, a relative speed of the own vehicle 1 and the other vehicle 2, whether the other vehicle 2 approaches or moves away from the own vehicle 1, and the like.

The inter-vehicle distance is an inter-vehicle distance between the own vehicle 1 and the other vehicle 2. The traveling situation derivation unit 20B determines a distance between the own vehicle 1 and the other vehicle 2 detected by the external sensor 14 as the inter-vehicle distance from the own vehicle 1 to the other vehicle 2. In addition, for example, by combining the captured image and object detection using an AI or the like trained by Deep Learning or the like, the traveling situation derivation unit 20B may estimate a distance in a pseudo manner using a well-known method based on a foot position, a width, or the like of an object to calculate the distance from the own vehicle 1 to the other vehicle 2 as the inter-vehicle distance. In addition, for example, the traveling situation derivation unit 20B may calculate a difference between the position of the own vehicle 1 detected by the internal sensor 15 and the position of the other vehicle 2 received from the other vehicle 2 through inter-vehicle communication or the like as the inter-vehicle distance between the own vehicle 1 and the other vehicle 2.

The lane is a strip-shaped region provided on a traveling path to allow vehicles in one line to pass. By analyzing the captured image using a well-known method, the traveling situation derivation unit 20B may determine the lane on which each of the own vehicle 1 and the other vehicle 2 is traveling and another lane that is a lane around the own vehicle 1 and where the own vehicle 1 is allowed to travel in the same direction as the traveling direction of the current traveling.

The relative speed represents a speed of the other vehicle 2 relative to the own vehicle 1. The traveling situation derivation unit 20B determines the relative speed of the other vehicle 2 to the own vehicle 1, for example, from a change in the position of the other vehicle 2 in the captured image. For example, when the imaging device 13 is a stereo camera, the traveling situation derivation unit 20B may acquire the relative speed of the other vehicle 2 from a chronological change in distance representing a disparity based on disparity information obtained from the stereo camera. The traveling situation derivation unit 20B may calculate the distance representing the disparity as the inter-vehicle distance between the own vehicle 1 and the other vehicle 2. In addition, the traveling situation derivation unit 20B may calculate the relative speed using the speed of the own vehicle 1 detected by the internal sensor 15 of the own vehicle 1 and the speed of the other vehicle 2 acquired from the other vehicle 2 through inter-vehicle communication.

In addition, by analyzing the calculated chronological change in the inter-vehicle distance between the own vehicle 1 and the other vehicle 2, the traveling situation derivation unit 20B determines that the other vehicle 2 moves away from the own vehicle 1 when the inter-vehicle distance increases over time. In addition, when the inter-vehicle distance decreases over time, the traveling situation derivation unit 20B may determine that the other vehicle 2 approaches the own vehicle 1.

Next, the first setting unit 20C and the second setting unit 20D will be described.

When the other vehicle 2 is determined to be the two-wheel vehicle 2A, the first setting unit 20C sets a first inter-vehicle distance that is changed from a first initial inter-vehicle distance in accordance with the first traveling situation information.

When the other vehicle 2 is determined to be the four-wheel vehicle 2B, the second setting unit 20D sets a second inter-vehicle distance that is changed from a second initial inter-vehicle distance in accordance with the second traveling situation information.

The first inter-vehicle distance is a threshold of the inter-vehicle distance between the own vehicle 1 and the two-wheel vehicle 2A for determining whether or not to output warning information regarding the two-wheel vehicle 2A to the passenger of the own vehicle 1. When the inter-vehicle distance between the own vehicle 1 and the two-wheel vehicle 2A is the first inter-vehicle distance or less, the output control unit 20E described below outputs the warning information regarding the two-wheel vehicle 2A (the details will be described below).

The second inter-vehicle distance is a threshold of the inter-vehicle distance between the own vehicle 1 and the four-wheel vehicle 2B for determining whether or not to output warning information regarding the four-wheel vehicle 2B to the passenger of the own vehicle 1. When the inter-vehicle distance between the own vehicle 1 and the four-wheel vehicle 2B is the second inter-vehicle distance or less, the output control unit 20E described below outputs the warning information regarding the four-wheel vehicle 2B (the details will be described below).

That is, in the present embodiment, when the inter-vehicle distance between the own vehicle 1 and the other vehicle 2 is the first inter-vehicle distance or less, in a case where the other vehicle 2 is the two-wheel vehicle 2A, the warning information regarding the two-wheel vehicle 2A is output. In addition, in the present embodiment, when the inter-vehicle distance between the own vehicle 1 and the other vehicle 2 is the second inter-vehicle distance or less, in a case where the other vehicle 2 is the four-wheel vehicle 2B, the warning information regarding the four-wheel vehicle 2B is output. Therefore, in the present embodiment, by using the threshold of the inter-vehicle distance depending on whether the other vehicle 2 is the two-wheel vehicle 2A or the four-wheel vehicle 2B, the warning information regarding the other vehicle 2 can be output (the details will be described below).

The first initial inter-vehicle distance is an initial value of the threshold of the inter-vehicle distance between the own vehicle 1 and the two-wheel vehicle 2A before being changed in accordance with the first traveling situation information. The second initial inter-vehicle distance is an initial value of the threshold of the inter-vehicle distance between the own vehicle 1 and the four-wheel vehicle 2B before being changed in accordance with the second traveling situation information. The first initial inter-vehicle distance is, for example, a distance longer than the second initial inter-vehicle distance.

In the storage unit 19, information representing each of the first initial inter-vehicle distance and the second initial inter-vehicle distance is previously stored. The first setting unit 20C or the second setting unit 20D sets the first inter-vehicle distance or the second inter-vehicle distance to the other vehicle 2 that is the two-wheel vehicle 2A or the four-wheel vehicle 2B determined by the vehicle determination unit 20A. For example, a case where the vehicle determination unit 20A determines the two-wheel vehicle 2A and the four-wheel vehicle 2B from the captured image is assumed. In this case, the first setting unit 20C sets the first inter-vehicle distance to the two-wheel vehicle 2A using the first traveling situation information regarding the two-wheel vehicle 2A. The second setting unit 20D sets the second inter-vehicle distance to the four-wheel vehicle 2B using the second traveling situation information regarding the four-wheel vehicle 2B. In addition, it is assumed that the vehicle determination unit 20A determines a plurality of the two-wheel vehicles 2A and a plurality of the four-wheel vehicles 2B from the captured image. In this case, the first setting unit 20C sets the first inter-vehicle distance for each of the two-wheel vehicles 2A using the first traveling situation information regarding each of the two-wheel vehicles 2A. In addition, the first setting unit 20D sets the second inter-vehicle distance for each of the four-wheel vehicles 2B using the second traveling situation information regarding each of the four-wheel vehicles 2B.

First, the first setting unit 20C will be described in detail.

The first setting unit 20C determines whether or not the first traveling situation information derived by the traveling situation derivation unit 20B matches with at least one of the following first conditions. The first setting unit 20C sets the first inter-vehicle distance that is changed from the first initial inter-vehicle distance depending on the matched first condition.

The first condition represents at least one condition out of a vehicle speed of the own vehicle 1 being a predetermined speed or higher, the number of times of changing a traveling direction of the two-wheel vehicle 2A being a predetermined number of times or more, traveling in a traveling environment at a predetermined illuminance or lower, a driving skill of a driver of the own vehicle 1 being a predetermined level of skill or lower, a driving skill of a driver of the two-wheel vehicle 2A being a predetermined level of skill or lower, an estimated size of the two-wheel vehicle 2A being a predetermined size or less, a color difference between the two-wheel vehicle 2A and a traveling road surface being a predetermined color difference or less, a traveling road of the own vehicle 1 and the two-wheel vehicle 2A being a road where high-speed traveling at a predetermined speed or higher is allowed, an estimated crash severity of the two-wheel vehicle 2A being a predetermined severity or more, a traveling site of the own vehicle 1 and the two-wheel vehicle 2A being in a predetermined warning target region, an environment of a traveling road surface of the own vehicle 1 and the two-wheel vehicle 2A being a predetermined vehicle rollover risk environment, a steering angle of the own vehicle 1 being a predetermined angle or more, deceleration of the own vehicle 1, a traveling region of the own vehicle 1 and the two-wheel vehicle 2A being in a predetermined area, a vehicle type of the two-wheel vehicle 2A being a preset warning target vehicle, and a predetermined operation by a passenger of the two-wheel vehicle 2A. In the present embodiment, a case where the first condition represents each of all these conditions will be described as an example. The first condition may represent at least one condition among these conditions.

The first setting unit 20C determines whether or not the vehicle speed of the own vehicle 1 in the first traveling situation information is a predetermined speed or higher. The predetermined speed may be previously set in response to the operation instruction or the like of the operation unit 17 by the user and previously stored in the storage unit 19. As the predetermined speed, for example, a speed that is a threshold for changing the first initial inter-vehicle distance to the first inter-vehicle distance farther than the first initial inter-vehicle distance may be preset. The predetermined speed can be changed in response to the operation instruction or the like of the operation unit 17 by the user.

When the vehicle speed of the own vehicle 1 in the first traveling situation information is the predetermined speed or higher, the first setting unit 20C sets the first inter-vehicle distance obtained by changing the first initial inter-vehicle distance to a farther distance. In addition, when the vehicle speed of the own vehicle 1 is the predetermined speed or higher, the first setting unit 20C may set the first inter-vehicle distance obtained by changing the first initial inter-vehicle distance to a farther distance as the vehicle speed becomes higher. Through these setting processes, the first setting unit 20C can enhance the output sensitivity of the warning information regarding the two-wheel vehicle 2A as the vehicle speed of the own vehicle 1 increases. In addition, when the vehicle speed of the own vehicle 1 in the first traveling situation information derived by the traveling situation derivation unit 20B is lower than the predetermined speed, the first setting unit 20C uses the first initial inter-vehicle distance as the first inter-vehicle distance. The two-wheel vehicle 2A may travel after passing the periphery of the own vehicle 1 that is traveling at a low speed due to congestion, waiting for a traffic light, or the like. Therefore, through the process, the first setting unit 20C can set the first inter-vehicle distance to output warning information regarding the two-wheel vehicle 2A when the inter-vehicle distance between the own vehicle 1 and the two-wheel vehicle 2A is less than the first initial inter-vehicle distance irrespective of the vehicle speed of the own vehicle 1.

In addition, the first setting unit 20C determines whether or not the number of times of changing the traveling direction of the two-wheel vehicle 2A in the first traveling situation information is the predetermined number of times or more. The predetermined number of times of changing the traveling direction may be previously set in response to the operation instruction or the like of the operation unit 17 by the user and previously stored in the storage unit 19. As the predetermined number of times, for example, a number of times that is a threshold for changing the first initial inter-vehicle distance to the first inter-vehicle distance farther than the first initial inter-vehicle distance may be preset. The predetermined number of times can be changed in response to the operation instruction or the like of the operation unit 17 by the user.

The first setting unit 20C reads the number of times of changing the traveling direction of the two-wheel vehicle 2A in the first traveling situation information. When the number of times of changing the traveling direction in the first traveling situation information is the predetermined number of times or more, the first setting unit 20C sets the first inter-vehicle distance obtained by changing the first initial inter-vehicle distance to a farther distance. In addition, when the number of changes in traveling is the predetermined number of times or more, the first setting unit 20C may set the first inter-vehicle distance obtained by changing the first initial inter-vehicle distance to a farther distance as the number of changes in traveling increases. Through these setting processes, the first setting unit 20C can enhance the output sensitivity of the warning information regarding the two-wheel vehicle 2A when the number of times of changing the traveling direction is the predetermined number of times or more.

In addition, the first setting unit 20C determines whether or not the illuminance of the traveling environment of the own vehicle 1 and the two-wheel vehicle 2A in the first traveling situation information is the predetermined illuminance or lower to determine whether or not the own vehicle 1 is traveling in the traveling environment at the predetermined illuminance or lower. The predetermined illuminance may be previously set in response to the operation instruction or the like of the operation unit 17 by the user and previously stored in the storage unit 19. As the predetermined illuminance, for example, an illuminance that is a threshold for changing the first initial inter-vehicle distance to the first inter-vehicle distance farther than the first initial inter-vehicle distance may be preset. The predetermined illuminance can be changed in response to the operation instruction or the like of the operation unit 17 by the user.

When the illuminance of the traveling environment is the predetermined illuminance or lower, the first setting unit 20C sets the first inter-vehicle distance obtained by changing the first initial inter-vehicle distance to a farther distance. Specifically, a case where the first initial inter-vehicle distance is 20 m is assumed. When the illuminance of the traveling environment is the predetermined illuminance or lower, for example, in a dark environment, the first setting unit 20C sets the first inter-vehicle distance obtained by changing the first initial inter-vehicle distance to a distance 30 m farther than the first initial inter-vehicle distance. In addition, when the illuminance of the traveling environment is the predetermined illuminance or lower, the first setting unit 20C may set the first inter-vehicle distance obtained by changing the first initial inter-vehicle distance to a farther distance as the illuminance becomes lower (darker). Through these setting processes, when the traveling environment of the own vehicle 1 and the two-wheel vehicle 2A is a dark traveling environment at the predetermined illuminance or lower, the first setting unit 20C can enhance the output sensitivity of the warning information regarding the two-wheel vehicle 2A.

In addition, the first setting unit 20C reads the driving skill of the driver of the own vehicle 1 in the first traveling situation information. The first setting unit 20C determines whether or not the driving skill of the driver of the own vehicle 1 is the predetermined level of skill or lower. The predetermined skill may be previously set in response to the operation instruction or the like of the operation unit 17 by the user and previously stored in the storage unit 19. As the predetermined skill, for example, a driving skill that is a threshold for changing the first initial inter-vehicle distance to the first inter-vehicle distance farther than the first initial inter-vehicle distance may be preset. The predetermined skill can be changed in response to the operation instruction or the like of the operation unit 17 by the user.

When the driving skill of the driver of the own vehicle 1 is the predetermined level of skill or lower, the first setting unit 20C sets the first inter-vehicle distance obtained by changing the first initial inter-vehicle distance to a farther distance. Specifically, when the driving skill of the driver of the own vehicle 1 is the predetermined level of skill or lower, the first setting unit 20C sets the first inter-vehicle distance obtained by changing the first initial inter-vehicle distance to a farther distance. In addition, when the driving skill of the driver of the own vehicle 1 is the predetermined level of skill or lower, the first setting unit 20C sets the first inter-vehicle distance obtained by changing the first initial inter-vehicle distance to a farther distance as the driving skill becomes lower. Through these setting processes, when the driving skill of the driver of the own vehicle 1 is low, for example, the predetermined level of skill or lower, the first setting unit 20C can enhance the output sensitivity of the warning information regarding the two-wheel vehicle 2A.

In addition, when the driving skill of the driver of the two-wheel vehicle 2A is the predetermined level of skill or lower, the first setting unit 20C sets the first inter-vehicle distance obtained by changing the first initial inter-vehicle distance to a farther distance. Specifically, when the driving skill of the driver of the two-wheel vehicle 2A is the predetermined level of skill or lower, the first setting unit 20C sets the first inter-vehicle distance obtained by changing the first initial inter-vehicle distance to a farther distance. In addition, when the driving skill of the driver of the two-wheel vehicle 2A is the predetermined level of skill or lower, the first setting unit 20C may set the first inter-vehicle distance obtained by changing the first initial inter-vehicle distance to a farther distance as the driving skill becomes lower. For example, when the two-wheel vehicle 2A quickly approaches the own vehicle 1, the driver of the own vehicle 1 is likely to quickly change the speed or the traveling position of the own vehicle 1 to avoid the two-wheel vehicle 2A. when the driving skill of the driver of the two-wheel vehicle 2A is low, for example, the predetermined level of skill or lower, it is expected that the driver of the two-wheel vehicle 2A has a difficulty in dealing with a quick change in the speed or the traveling position of the own vehicle 1. In order to avoid such an event, through these setting processes, the first setting unit 20C can enhance the output sensitivity of the warning information regarding the two-wheel vehicle 2A.

By receiving the driving skill of the driver determined by the two-wheel vehicle 2A from the two-wheel vehicle 2A through V2V (inter-vehicle communication), the first setting unit 20C may acquire the driving skill of the driver of the two-wheel vehicle 2A to use the driving skill for the above-described setting processes. The two-wheel vehicle 2A may determine the driving skill by calculating the driving skill of the driver using a well-known method, for example, from the driving operation of the driver of the two-wheel vehicle 2A. In addition, identification information of the driver of the two-wheel vehicle 2A and the driving skill of the driver are previously stored in a portable terminal such as a smartphone carried by the driver in association with each other, and when the lock of the two-wheel vehicle 2A is released using the portable terminal as a key, the identification information and the driving skill are transmitted from the portable terminal to the two-wheel vehicle 2A. The two-wheel vehicle 2A may determine the driving skill of the driver of the two-wheel vehicle 2A by receiving the identification information and the driving skill from the portable terminal. In addition, the first setting unit 20C may acquire the driving skill of the driver of the two-wheel vehicle 2A by analyzing the two-wheel vehicle 2A in the captured image using a well-known method and estimating a braking operation or the like of the two-wheel vehicle 2A.

In addition, the first setting unit 20C reads the estimated size of the two-wheel vehicle 2A in the first traveling situation information. The first setting unit 20C determines whether or not the estimated size of the two-wheel vehicle 2A is the predetermined size or less. The predetermined size of the two-wheel vehicle 2A may be previously set in response to the operation instruction or the like of the operation unit 17 by the user and previously stored in the storage unit 19. As the predetermined size of the two-wheel vehicle 2A, for example, a size of the two-wheel vehicle 2A that is a threshold for changing the first initial inter-vehicle distance to the first inter-vehicle distance farther than the first initial inter-vehicle distance may be preset. The predetermined size of the two-wheel vehicle 2A can be appropriately changed in response to the operation instruction or the like of the operation unit 17 by the user.

When the estimated size of the two-wheel vehicle 2A is the predetermined size or less, the first setting unit 20C sets the first inter-vehicle distance obtained by changing the first initial inter-vehicle distance to a farther distance. In addition, when the estimated size of the two-wheel vehicle 2A is the predetermined size or less, the first setting unit 20C sets the first inter-vehicle distance obtained by changing the first initial inter-vehicle distance to a farther distance as the estimated size decreases. Through these setting processes, when the estimated size of the two-wheel vehicle 2A is the predetermined size or less, namely, is not noticeable by the driver, the first setting unit 20C can enhance the output sensitivity of the warning information regarding the small two-wheel vehicle 2A.

In addition, the first setting unit 20C reads the color difference between the color of the two-wheel vehicle 2A and the color of the traveling road surface of the two-wheel vehicle 2A in the first traveling situation information. The first setting unit 20C determines whether or not the color difference is the predetermined color difference or less. The predetermined color difference may be previously set in response to the operation instruction or the like of the operation unit 17 by the user and previously stored in the storage unit 19. As the predetermined color difference, for example, a color difference that is a threshold for changing the first initial inter-vehicle distance to the first inter-vehicle distance farther than the first initial inter-vehicle distance may be preset. The predetermined color difference can be changed in response to the operation instruction or the like of the operation unit 17 by the user.

When the color difference between the color of the two-wheel vehicle 2A and the color of the traveling road surface of the two-wheel vehicle 2A is the predetermined color difference or less, the first setting unit 20C sets the first inter-vehicle distance obtained by changing the first initial inter-vehicle distance to a farther distance. In addition, when the color difference is the predetermined color difference or less, the first setting unit 20C may set the first inter-vehicle distance obtained by changing the first initial inter-vehicle distance to a farther distance as the color difference decreases. Through these setting processes, when the color difference between the color of the two-wheel vehicle 2A and the color of the traveling road surface of the two-wheel vehicle 2A is the predetermined color difference or less, for example, when the two-wheel vehicle 2A and the traveling road surface are likely to be similar to each other with the color difference, namely, when the two-wheel vehicle 2A is not more noticeable by the driver, the first setting unit 20C can enhance the output sensitivity of the warning information regarding the two-wheel vehicle 2A.

In addition, the first setting unit 20C reads the type of the traveling road where the own vehicle 1 and the two-wheel vehicle 2A are traveling in the first traveling situation information. The first setting unit 20C determines whether or not the type of the traveling road where the own vehicle 1 and the two-wheel vehicle 2A are traveling is a road where high-speed traveling at the predetermined speed or higher is allowed. As described above, the traveling situation derivation unit 20B determines the type of the traveling road representing whether the traveling road where the own vehicle 1 and the two-wheel vehicle 2A are traveling is a highway or a general road. Therefore, by reading a result of the determination, the first setting unit 20C determines whether or not the type of the traveling road where the own vehicle 1 and the two-wheel vehicle 2A are traveling is a highway.

In response to determining that the type of the traveling road where the own vehicle 1 and the two-wheel vehicle 2A are traveling is a highway, the first setting unit 20C sets the first inter-vehicle distance obtained by changing the first initial inter-vehicle distance to a farther distance. In addition, as the upper speed limit of the highway where the own vehicle 1 and the two-wheel vehicle 2A are traveling increases, the first setting unit 20C may set the first inter-vehicle distance obtained by changing the first initial inter-vehicle distance to a farther distance. Through these setting processes, when the type of the traveling road where the own vehicle 1 and the two-wheel vehicle 2A are traveling is a highway, the first setting unit 20C can enhance the output sensitivity of the warning information regarding the two-wheel vehicle 2A.

In addition, when the type of the traveling road where the own vehicle 1 and the two-wheel vehicle 2A are traveling is a highway and the estimated crash severity during crash of the two-wheel vehicle 2A with another object is less than the predetermined severity, the first setting unit 20C sets the first initial inter-vehicle distance as the first inter-vehicle distance. The first setting unit 20C may read the estimated crash severity during crash of the two-wheel vehicle 2A with another object in the first traveling situation information to use the estimated crash severity for the setting processes. Through these setting processes, the first setting unit 20C can set the first initial inter-vehicle distance as the first inter-vehicle distance without enhancing the output sensitivity for the two-wheel vehicle 2A having a low estimated crash severity during high-speed traveling.

When the estimated crash severity of the two-wheel vehicle 2A is less than the predetermined severity, the first setting unit 20C may set the first initial inter-vehicle distance as the first inter-vehicle distance irrespective of the type of the traveling road where the two-wheel vehicle 2A is traveling. In addition, when the estimated crash severity of the two-wheel vehicle 2A is the predetermined severity or more, the first setting unit 20C may set the first inter-vehicle distance obtained by changing the first initial inter-vehicle distance to a farther distance irrespective of the type of the traveling road where the two-wheel vehicle 2A is traveling. Through these setting processes, when the estimated crash severity of the two-wheel vehicle 2A is the predetermined severity or more, the first setting unit 20C can enhance the output sensitivity of the warning information regarding the two-wheel vehicle 2A.

In addition, the first setting unit 20C reads the determination result of whether or not the current traveling site of the own vehicle 1 and the two-wheel vehicle 2A is in the warning target region in the first traveling situation information. When the determination result represents that the current traveling site of the own vehicle 1 and the two-wheel vehicle 2A is in the warning target region, the first setting unit 20C sets the first inter-vehicle distance obtained by changing the first initial inter-vehicle distance to a farther distance.

As described above, the warning target region is, for example, an intersection or a junction of a highway. Through these setting processes, when the own vehicle 1 is traveling in the warning target region such as an intersection or a junction of a highway, the first setting unit 20C can enhance the output sensitivity of the warning information regarding the two-wheel vehicle 2A.

The traveling situation derivation unit 20B may use the position of the own vehicle 1 detected by a GPS in the internal sensor 15 for determining whether or not the current traveling site of the own vehicle 1 and the two-wheel vehicle 2A is in the warning target region. In this case, when the position of the own vehicle 1 cannot be acquired by the GPS, it is preferable that the output control unit 20E described below forcibly turns off the output of the warning information. Through this process, the output control unit 20E can suppress erroneous output of the warning information.

In addition, the first setting unit 20C reads the determination result of whether or not the environment of the traveling road surface of the own vehicle 1 and the two-wheel vehicle 2A is the predetermined vehicle rollover risk environment in the first traveling situation information. The first setting unit 20C determines whether or not the determination results represents that the environment of the traveling road surface of the own vehicle 1 and the two-wheel vehicle 2A is the predetermined vehicle rollover risk environment.

In response to determining that the environment of the traveling road surface of the own vehicle 1 and the two-wheel vehicle 2A is the predetermined vehicle rollover risk environment, the first setting unit 20C sets the first inter-vehicle distance obtained by changing the first initial inter-vehicle distance to a longer distance. As described above, the vehicle rollover risk environment is information representing that the traveling road surface of the own vehicle 1 and the two-wheel vehicle 2A is an environment where the two-wheel vehicle 2A is likely to roll over. Specifically, the vehicle rollover risk environment is represented by information representing a road surface environment such as freezing, rainy weather, or snow accumulation. Through these setting processes, when the two-wheel vehicle 2A is traveling in the vehicle rollover risk environment where rollover is likely to occur and a braking distance is long, the first setting unit 20C can enhance the output sensitivity of the warning information regarding the two-wheel vehicle 2A.

In addition, the first setting unit 20C reads the steering angle of the own vehicle 1 in the first traveling situation information. The first setting unit 20C determines whether or not the steering angle of the own vehicle 1 is the predetermined angle or more. The predetermined angle may be previously set in response to the operation instruction or the like of the operation unit 17 by the user and previously stored in the storage unit 19. As the predetermined angle, for example, a steering angle that is a threshold for changing the first initial inter-vehicle distance to the first inter-vehicle distance farther than the first initial inter-vehicle distance may be preset. The predetermined angle can be changed in response to the operation instruction or the like of the operation unit 17 by the user.

When the steering angle of the own vehicle 1 is the predetermined angle or more, the first setting unit 20C sets the first inter-vehicle distance obtained by changing the first initial inter-vehicle distance to a farther distance. In addition, when the steering angle of the own vehicle 1 is the predetermined angle or more, the first setting unit 20C may set the first inter-vehicle distance obtained by changing the first initial inter-vehicle distance to a farther distance as the steering angle increases. When the own vehicle 1 turns left or right or is traveling in a curved road having a high curvature, the risk of an accident involving the two-wheel vehicle 2A is increases. Through these setting processes, when the steering angle of the own vehicle 1 is the predetermined angle or more, the first setting unit 20C can enhance the output sensitivity of the warning information regarding the two-wheel vehicle 2A, and the risk can be reduced.

In addition, the first setting unit 20C reads the information representing the situation of the acceleration and deceleration of the own vehicle 1 in the first traveling situation information. When the information representing the situation of the acceleration and deceleration of the own vehicle 1 represents the deceleration of the own vehicle 1, the first setting unit 20C sets the first inter-vehicle distance obtained by changing the first initial inter-vehicle distance to a farther distance. The two-wheel vehicle 2A has a longer braking distance than the four-wheel vehicle 2B. Therefore, through these setting processes, when the deceleration of the own vehicle 1 is detected, the first setting unit 20C can enhance the output sensitivity of the warning information regarding the two-wheel vehicle 2A. In addition, when the deceleration of the own vehicle 1 is detected, the output control unit 20E described below may output the warning information in an output form for calling more attention of the user.

In addition, the first setting unit 20C reads the area including the traveling region where the own vehicle 1 and the two-wheel vehicle 2A are traveling in the first traveling situation information. As described above, the area is information representing a country or an area where the own vehicle 1 and the two-wheel vehicle 2A are traveling.

The first setting unit 20C determines whether or not the area where the own vehicle 1 and the two-wheel vehicle 2A are traveling is in the predetermined region. The predetermined region is, for example, an area having a high traveling density of the two-wheel vehicle 2A or an area having a low traveling density of the two-wheel vehicle 2A. The predetermined region may be set in response to the operation instruction or the like of the operation unit 17 by the user and previously stored in the storage unit 19.

When the area where the own vehicle 1 and the two-wheel vehicle 2A are traveling is the area having a high traveling density of the two-wheel vehicle 2A, the first setting unit 20C sets the first inter-vehicle distance obtained by changing the first initial inter-vehicle distance to a closer distance. In addition, when the area where the own vehicle 1 and the two-wheel vehicle 2A are traveling is the area having a low traveling density of the two-wheel vehicle 2A, the first setting unit 20C may set the first inter-vehicle distance obtained by changing the first initial inter-vehicle distance to a farther distance. Through these setting processes, when the area where the own vehicle 1 and the two-wheel vehicle 2A are traveling is the area having a high traveling density of the two-wheel vehicle 2A, the first setting unit 20C can reduce the output sensitivity of the warning information regarding the two-wheel vehicle 2A, and can suppress frequent output of the warning information. In addition, when the area where the own vehicle 1 and the two-wheel vehicle 2A are traveling is the area having a low traveling density of the two-wheel vehicle 2A, the first setting unit 20C can enhance the output sensitivity of the warning information regarding the two-wheel vehicle 2A.

In addition, the first setting unit 20C reads the determination result of the vehicle type of the two-wheel vehicle 2A in the first traveling situation information. The first setting unit 20C determines whether or not the read vehicle type of the two-wheel vehicle 2A is the warning target vehicle. As described above, the warning target vehicle is a vehicle of the vehicle type that is a target of warning to the own vehicle 1, for example, a motorcycle attached with various devices required for traffic control work by the police. In addition, as described above, in the present embodiment, the traveling situation derivation unit 20B determines whether or not the vehicle type of the two-wheel vehicle 2A is the warning target vehicle. Therefore, the first setting unit 20C determines whether or not the vehicle type of the two-wheel vehicle 2A is the warning target vehicle by reading the determination result in the first traveling situation information.

When the vehicle type of the two-wheel vehicle 2A is the warning target vehicle, the first setting unit 20C sets the first inter-vehicle distance obtained by changing the first initial inter-vehicle distance to a farther distance. Through this setting process, the first setting unit 20C can enhance the output sensitivity of the warning information regarding the two-wheel vehicle 2A that is the warning target vehicle.

In addition, the first setting unit 20C reads the operation of the passenger of the two-wheel vehicle 2A in the first traveling situation information. The first setting unit 20C determines whether or not the operation of the passenger of the two-wheel vehicle 2A is the predetermined operation. The predetermined operation is, for example, an operation of the passenger of the two-wheel vehicle 2A for calling attention for at least one of the two-wheel vehicle 2A and the passenger of the two-wheel vehicle 2A. Specifically, the predetermined operation is an operation such as swinging of an arm by the passenger of the two-wheel vehicle 2A. The predetermined operation may be previously set in response to the operation instruction or the like of the operation unit 17 by the user and previously stored in the storage unit 19. The predetermined operation can be changed in response to the operation instruction or the like of the operation unit 17 by the user.

In response to determining that the operation of the passenger of the two-wheel vehicle 2A is the predetermined operation, the first setting unit 20C sets the first inter-vehicle distance obtained by changing the first initial inter-vehicle distance to a farther distance. When the passenger of the two-wheel vehicle 2A executes the predetermined operation, it is presumed that the passenger is in a state where the passenger wants some kind of communication with the own vehicle 1 through the operation. Therefore, through these setting processes, when the passenger of the two-wheel vehicle 2A executes the predetermined operation, the first setting unit 20C can enhance the output sensitivity of the warning information regarding the two-wheel vehicle 2A.

The first traveling situation information may match with two or more conditions among the above-described first conditions. In this case, the first setting unit 20C may set the first inter-vehicle distance that is changed from the first initial inter-vehicle distance in accordance with the matched first conditions. For example, it is assumed that the first traveling situation information matches with a plurality of first conditions for changing the first initial inter-vehicle distance to a farther distance. In this case, the first setting unit 20C may set the first inter-vehicle distance obtained by changing the first initial inter-vehicle distance to a farther distance as the number of the matched first conditions increases. In addition, the first conditions that match with the first traveling situation information may include first conditions for changing the first initial inter-vehicle distance to a shorter distance. In this case, assuming that the distance increased by each of the first conditions that match with the first traveling situation information is a positive distance and the distance decreased by each of the first conditions is a negative distance, the first setting unit 20C may set a value obtained by adding the sum of the distances and the first initial inter-vehicle distance as the first inter-vehicle distance.

First, the second setting unit 20D will be described in detail.

The second setting unit 20D determines whether or not the second traveling situation information derived by the traveling situation derivation unit 20B matches with at least one of the following second conditions. The second setting unit 20D sets the second inter-vehicle distance that is changed from the second initial inter-vehicle distance in accordance with the matched second condition.

The second condition represents at least one condition out of a vehicle speed of the own vehicle 1 being a predetermined speed or higher, an estimated size of the four-wheel vehicle 2B being a predetermined size or more, a traveling road of the own vehicle 1 and the four-wheel vehicle 2B being a road where high-speed traveling at a predetermined speed or higher is allowed and an estimated crash severity of the four-wheel vehicle 2B that is traveling in the road being a predetermined severity or more, an estimated crash severity of the four-wheel vehicle 2B being a predetermined severity or more, a traveling site of the own vehicle 1 and the four-wheel vehicle 2B being in a predetermined warning target region, a vehicle registration number of the four-wheel vehicle 2B being a preset number, a traveling region of the own vehicle 1 and the four-wheel vehicle 2B being in a predetermined area, and a vehicle type of the four-wheel vehicle 2B being a preset warning target vehicle. In the present embodiment, a case where the second condition represents each of all these conditions will be described as an example. The second condition may represent at least one condition among these conditions.

The second setting unit 20D determines whether or not the vehicle speed of the own vehicle 1 in the second traveling situation information is a predetermined speed or higher. The predetermined speed may be previously set in response to the operation instruction or the like of the operation unit 17 by the user and previously stored in the storage unit 19. As the predetermined speed, for example, a speed that is a threshold for changing the second initial inter-vehicle distance to the second inter-vehicle distance farther than the second initial inter-vehicle distance may be preset. The predetermined speed can be changed in response to the operation instruction or the like of the operation unit 17 by the user. The predetermined speed used for the second setting unit 20D to determine the vehicle speed in the second traveling situation information may be the same or different from the predetermined speed used for the first setting unit 20C to determine the vehicle speed in the first traveling situation information.

When the vehicle speed of the own vehicle 1 in the second traveling situation information is the predetermined speed or higher, the second setting unit 20D sets the second inter-vehicle distance obtained by changing the second initial inter-vehicle distance to a farther distance. In addition, when the vehicle speed of the own vehicle 1 is the predetermined speed or higher, the second setting unit 20D may set the second inter-vehicle distance obtained by changing the second initial inter-vehicle distance to a farther distance as the vehicle speed becomes higher. Through these setting processes, the second setting unit 20D can enhance the output sensitivity of the warning information regarding the four-wheel vehicle 2B as the vehicle speed of the own vehicle 1 increases.

As described above, when the vehicle speed of the own vehicle 1 in the first traveling situation information is the predetermined speed or higher, the first setting unit 20C sets the first inter-vehicle distance obtained by changing the first initial inter-vehicle distance to a farther distance. Therefore, in the information processing device 10 according to the present embodiment, when the vehicle speed of the own vehicle 1 is the predetermined speed or higher, in both cases where the other vehicle 2 in the captured image is the two-wheel vehicle 2A and the four-wheel vehicle 2B, the output sensitivity of the warning information regarding each of the two-wheel vehicle 2A and the four-wheel vehicle 2B can be enhanced.

In addition, the second setting unit 20D reads the estimated size of the four-wheel vehicle 2B in the second traveling situation information. The second setting unit 20D determines whether or not the estimated size of the four-wheel vehicle 2B is the predetermined size or more. The predetermined size of the four-wheel vehicle 2B may be previously set in response to the operation instruction or the like of the operation unit 17 by the user and previously stored in the storage unit 19. As the predetermined size of the four-wheel vehicle 2B, a size that is a threshold for determining whether or not damage to the own vehicle 1 during crash between the four-wheel vehicle 2B and the own vehicle 1 is large may be preset. The predetermined size of the four-wheel vehicle 2B can be appropriately changed in response to the operation instruction or the like of the operation unit 17 by the user.

When the estimated size of the four-wheel vehicle 2B is the predetermined size or more, the second setting unit 20D sets the second inter-vehicle distance obtained by changing the second initial inter-vehicle distance to a farther distance. In addition, when the estimated size of the four-wheel vehicle 2B is the predetermined size or more, the second setting unit 20D may set the second inter-vehicle distance obtained by changing the second initial inter-vehicle distance to a farther distance as the estimated size increases. Through these setting processes, when the estimated size of the four-wheel vehicle 2B is the predetermined size or more, namely, is large such that damage to the own vehicle 1 is large during the crash, the second setting unit 20D can enhance the output sensitivity of the warning information regarding the large four-wheel vehicle 2B.

As described above, when the estimated size of the two-wheel vehicle 2A is the predetermined size or less, the first setting unit 20C sets the first inter-vehicle distance obtained by changing the first initial inter-vehicle distance to a farther distance. The reason for the setting processes is that, since the two-wheel vehicle 2A has a smaller size than the four-wheel vehicle 2B and is less recognizable by the passenger of the own vehicle 1, the warning information regarding the two-wheel vehicle 2A is more likely to be output as the size decreases. On the other hand, with regard to the four-wheel vehicle 2B, when the estimated size of the four-wheel vehicle 2B is the predetermined size or more, the second setting unit 20D sets the second inter-vehicle distance obtained by changing the second initial inter-vehicle distance to a farther distance. The reason for this is as follows. The four-wheel vehicle 2B has a larger size than the two-wheel vehicle 2A and is easily recognizable by the passenger of the own vehicle 1. Therefore, regarding vehicles other than the large four-wheel vehicle 2B where damage to the own vehicle 1 is large during crash, the warning information regarding the four-wheel vehicle 2B is not output until the inter-vehicle distance between the own vehicle 1 and the four-wheel vehicle 2B is short.

In addition, the second setting unit 20D reads the type of the traveling road where the own vehicle 1 and the four-wheel vehicle 2B are traveling and the estimated crash severity during crash of the four-wheel vehicle 2B with another object in the second traveling situation information. The second setting unit 20D determines whether or not the traveling road of the own vehicle 1 and the four-wheel vehicle 2B are a road where high-speed traveling at a predetermined speed or higher is allowed and the estimated crash severity of the four-wheel vehicle 2B that is traveling in the road is the predetermined severity or more. As described above, the traveling situation derivation unit 20B determines the type of the traveling road representing whether the traveling road where the own vehicle 1 and the four-wheel vehicle 2B are traveling is a highway or a general road. Therefore, by reading the determination result with the traveling situation derivation unit 20B, the second setting unit 20D determines whether or not the type of the traveling road where the own vehicle 1 and the four-wheel vehicle 2B are traveling is a highway.

In response to determining that the type of the traveling road where the own vehicle 1 and the four-wheel vehicle 2B are traveling is a highway, the second setting unit 20D reads the estimated crash severity of the four-wheel vehicle 2B that is traveling in the highway from the second traveling situation information. The second setting unit 20D determines whether or not the read estimated crash severity is the predetermined severity or more. The predetermined severity may be previously set in response to the operation instruction or the like of the operation unit 17 by the user and previously stored in the storage unit 19. As the predetermined severity, a severity that is a threshold for determining whether or not damage to the own vehicle 1 during crash between the four-wheel vehicle 2B and the own vehicle 1 that are traveling in the highway is large may be preset. The predetermined severity can be appropriately changed in response to the operation instruction or the like of the operation unit 17 by the user.

When the traveling road of the own vehicle 1 and the four-wheel vehicle 2B are a road where high-speed traveling at a predetermined speed or higher is allowed and the estimated crash severity of the four-wheel vehicle 2B that is traveling in the road is the predetermined severity or more, the first setting unit 20C sets the second inter-vehicle distance obtained by changing the second initial inter-vehicle distance to a farther distance. In addition, when the traveling road of the own vehicle 1 and the four-wheel vehicle 2B are a road where high-speed traveling at a predetermined speed or higher is allowed and the estimated crash severity of the four-wheel vehicle 2B that is traveling in the road is the predetermined severity or more, the second setting unit 20D sets the second inter-vehicle distance obtained by changing the second initial inter-vehicle distance to a farther distance as the estimated crash severity increases. Through these setting processes, the second setting unit 20D can enhance the output sensitivity of the warning information regarding the four-wheel vehicle 2B where damage to the own vehicle 1 during crash is large.

As described above, in response to determining that the type of the traveling road where the two-wheel vehicle 2A in the captured image is traveling is a highway, the first setting unit 20C sets the first inter-vehicle distance obtained by changing the first initial inter-vehicle distance to a farther distance. On the other hand, only when the type of the traveling road where the four-wheel vehicle 2B in the captured image is traveling is a highway, the second setting unit 20D does not change the second inter-vehicle distance. The reason for this is as follows. Since it is expected that automated driving of the two-wheel vehicle 2A is technically difficult even in a specific road such as a highway, the warning information regarding the two-wheel vehicle 2A is quickly or preferentially output. Regarding the four-wheel vehicle 2B, since the automated driving is not technically difficult in the specific road such as a highway, the warning information is not preferentially output when the type of the traveling road where the four-wheel vehicle 2B is traveling is only a highway.

In addition, as described above, when the type of the traveling road where the two-wheel vehicle 2A in the captured image is traveling is a highway and the estimated crash severity of the two-wheel vehicle 2A is less than the predetermined severity, the first setting unit 20C sets the first initial inter-vehicle distance as the first inter-vehicle distance. The reason for this is that the warning information is not preferentially output regarding the two-wheel vehicle 2A where the estimated crash severity during traveling in the highway is small. On the other hand, when the type of the traveling road where the four-wheel vehicle 2B in the captured image is traveling is a highway and the estimated crash severity of the four-wheel vehicle 2B is the predetermined severity or more, the second setting unit 20D sets the second inter-vehicle distance obtained by changing the second initial inter-vehicle distance to a farther distance. The reason for this is that the warning information is preferentially output regarding the four-wheel vehicle 2B where the mass is larger and the crash severity is larger than the two-wheel vehicle 2A during traveling in the highway.

In addition, when the estimated crash severity of the four-wheel vehicle 2B is less than the predetermined severity, the second setting unit 20D sets the second initial inter-vehicle distance as the second inter-vehicle distance irrespective of the type of the traveling road where the four-wheel vehicle 2B is traveling. In addition, when the estimated crash severity of the four-wheel vehicle 2B is the predetermined severity or more, the second setting unit 20D sets the second inter-vehicle distance obtained by changing the second initial inter-vehicle distance to a farther distance irrespective of the type of the traveling road where the four-wheel vehicle 2B is traveling. Through these setting processes, when the estimated crash severity of the four-wheel vehicle 2B is the predetermined severity or more, the second setting unit 20D can enhance the output sensitivity of the warning information regarding the four-wheel vehicle 2B.

In addition, the second setting unit 20D reads the determination result of whether or not the current traveling site of the own vehicle 1 and the four-wheel vehicle 2B is in the warning target region in the second traveling situation information. When the determination result represents that the current traveling site of the own vehicle 1 and the four-wheel vehicle 2B is in the warning target region, the second setting unit 20D sets the second inter-vehicle distance obtained by changing the second initial inter-vehicle distance to a farther distance. The warning target region may be a predetermined dangerous region in the case of the four-wheel vehicle 2B. In addition, since the four-wheel vehicle 2B is more easily recognizable by the passenger of the own vehicle 1 than the two-wheel vehicle 2A, the warning target region may be configured not to include an intersection or a junction of a highway.

Through these setting processes, when the own vehicle 1 is traveling in the warning target region, the second setting unit 20D can enhance the output sensitivity of the warning information regarding the four-wheel vehicle 2B.

The traveling situation derivation unit 20B may derive the traveling situation information using the position of the own vehicle 1 detected by the GPS in the internal sensor 15. In this case, when the position of the own vehicle 1 cannot be acquired by the GPS, it is preferable that the output control unit 20E described below forcibly turns off the output of the warning information. Through this process, erroneous output of the warning information can be suppressed.

In addition, the second setting unit 20D reads the vehicle registration number of the four-wheel vehicle 2B in the second traveling situation information. The second setting unit 20D determines whether or not the vehicle registration number of the four-wheel vehicle 2B is the preset number. The set number may be previously set in response to the operation instruction or the like of the operation unit 17 by the user and previously stored in the storage unit 19. The set number can be changed in response to the operation instruction or the like of the operation unit 17 by the user.

When the vehicle registration number of the four-wheel vehicle 2B is the preset number, the second setting unit 20D sets the second inter-vehicle distance obtained by changing the second initial inter-vehicle distance to a longer distance. Through these setting processes, the second setting unit 20D can enhance the output sensitivity of the warning information regarding the four-wheel vehicle 2B of which the vehicle registration number is the specific set number.

On the other hand, the first setting unit 20C does not determine the vehicle registration number of the two-wheel vehicle 2A regarding the two-wheel vehicle 2A in the captured image. The reason for this is that, since the vehicle registration number of the two-wheel vehicle 2A is not attached to the front side of the vehicle body, there is a high possibility that the vehicle registration number is not imaged in the captured image.

In addition, the second setting unit 20D reads the area including the traveling region where the own vehicle 1 and the four-wheel vehicle 2B are traveling in the second traveling situation information. As described above, the area is information representing a country or an area where the own vehicle 1 and the four-wheel vehicle 2B are traveling.

The second setting unit 20D determines whether or not the area where the own vehicle 1 and the four-wheel vehicle 2B are traveling is in the predetermined region. The predetermined region is, for example, an area having a high traveling density of the two-wheel vehicle 2A or an area having a low traveling density of the two-wheel vehicle 2A. The predetermined region may be previously set in response to the operation instruction or the like of the operation unit 17 by the user and previously stored in the storage unit 19.

When the area where the own vehicle 1 and the four-wheel vehicle 2B are traveling is the area having a low traveling density of the two-wheel vehicle 2A, the second setting unit 20D sets the second inter-vehicle distance obtained by changing the second initial inter-vehicle distance to a closer distance. In addition, when the area where the own vehicle 1 and the four-wheel vehicle 2B are traveling is the area having a high traveling density of the two-wheel vehicle 2A, the second setting unit 20D sets the second initial inter-vehicle distance as the second inter-vehicle distance. Through these setting processes, when the area where the own vehicle 1 and the four-wheel vehicle 2B are traveling is the area having a low traveling density of the two-wheel vehicle 2A, in other words, is the area having a high traveling density of the four-wheel vehicle 2B, the second setting unit 20D can reduce the output sensitivity of the warning information regarding the four-wheel vehicle 2B, and can suppress frequent output of the warning information.

As described above, when the area where the two-wheel vehicle 2A is traveling is the area having a high traveling density of the two-wheel vehicle 2A, the first setting unit 20C sets the first inter-vehicle distance obtained by changing the first initial inter-vehicle distance to a closer distance. The reason for this is that, in the own vehicle 1 that is traveling in the area having a high traveling density of the two-wheel vehicle 2A, frequent output of the warning information due to frequent detection of the two-wheel vehicle 2A is suppressed. On the other hand, when the area where the four-wheel vehicle 2B is traveling is the area having a low traveling density of the two-wheel vehicle 2A, the second setting unit 20D sets the second inter-vehicle distance obtained by changing the second initial inter-vehicle distance to a closer distance. The reason for this is that, since the traveling density of the four-wheel vehicle 2B is relatively high in the area having a low traveling density of the two-wheel vehicle 2A, the output sensitivity of the warning information regarding the four-wheel vehicle 2B is reduced.

In addition, the second setting unit 20D reads the determination result of the vehicle type of the four-wheel vehicle 2B in the second traveling situation information. The second setting unit 20D determines whether or not the read vehicle type of the four-wheel vehicle 2B is the warning target vehicle. As described above, the warning target vehicle of the four-wheel vehicle 2B is a vehicle of the vehicle type that is a target of warning to the own vehicle 1, for example, a large-sized vehicle or a special vehicle such as a police vehicle, an emergency vehicle, a fire vehicle, a bus, a taxi, or a truck. In addition, as described above, in the present embodiment, the traveling situation derivation unit 20B determines whether or not the vehicle type of the four-wheel vehicle 2B is the warning target vehicle. Therefore, the second setting unit 20D determines whether or not the vehicle type of the four-wheel vehicle 2B is the warning target vehicle by reading the determination result in the second traveling situation information.

When the vehicle type of the four-wheel vehicle 2B is the warning target vehicle, the second setting unit 20D sets the second inter-vehicle distance obtained by changing the second initial inter-vehicle distance to a farther distance. Through this setting process, the second setting unit 20D can enhance the output sensitivity of the warning information regarding the four-wheel vehicle 2B that is the warning target vehicle.

As described above, when the vehicle type of the two-wheel vehicle 2A is the warning target vehicle, the first setting unit 20C sets the first inter-vehicle distance obtained by changing the first initial inter-vehicle distance to a farther distance. In addition, when the vehicle type of the four-wheel vehicle 2B is the warning target vehicle, the second setting unit 20D sets the second inter-vehicle distance obtained by changing the second initial inter-vehicle distance to a farther distance. The reason for this is that, irrespective of whether the warning target vehicle is the two-wheel vehicle 2A or the four-wheel vehicle 2B, the output sensitivity of the warning information regarding the other vehicle 2 is improved.

In addition, as described above, when the number of times of changing the traveling direction of the two-wheel vehicle 2A is the predetermined number of times or more, the first setting unit 20C sets the first inter-vehicle distance obtained by changing the first initial inter-vehicle distance to a farther distance. On the other hand, the second setting unit 20D does not use the number of changes in traveling of the four-wheel vehicle 2B for the setting process of the second inter-vehicle distance. The reason for this is that the four-wheel vehicle 2B has a lower possibility of frequently changing the traveling direction than the two-wheel vehicle 2A.

In addition, as described above, when the illuminance of the traveling environment of the two-wheel vehicle 2A is the predetermined illuminance or lower, the first setting unit 20C sets the first inter-vehicle distance obtained by changing the first initial inter-vehicle distance to a farther distance. On the other hand, the second setting unit 20D does not use the illuminance of the traveling environment of the four-wheel vehicle 2B for the setting process of the second inter-vehicle distance. The reason for this is that the two-wheel vehicle 2A has a smaller size than the four-wheel vehicle 2B and is less recognizable by the passenger of the own vehicle 1; whereas the four-wheel vehicle 2B has a larger size than the two-wheel vehicle 2A and is easily recognizable by the passenger of the own vehicle 1 irrespective of the illuminance.

In addition, as described above, when the driving skill of the driver of the own vehicle 1 is the predetermined level of skill or lower, the first setting unit 20C sets the first inter-vehicle distance obtained by changing the first initial inter-vehicle distance to the two-wheel vehicle 2A to a farther distance. On the other hand, the second setting unit 20D does not use the driving skill of the driver of the own vehicle 1 for setting the second inter-vehicle distance. The reason for this is that, since the two-wheel vehicle 2A has a smaller size than the four-wheel vehicle 2B and is less recognizable by the passenger of the own vehicle 1, it is preferable to enhance the output sensitivity of the warning information regarding the two-wheel vehicle 2A when the driving skill of the driver is low. In addition, the four-wheel vehicle 2B has a larger size than the two-wheel vehicle 2A and thus is easily recognizable by the passenger of the own vehicle 1 irrespective of the driving skill of the driver.

In addition, as described above, when the color difference between the color of the two-wheel vehicle 2A and the color of the traveling road surface of the two-wheel vehicle 2A is the predetermined color difference or less, the first setting unit 20C sets the first inter-vehicle distance obtained by changing the first initial inter-vehicle distance to a farther distance. On the other hand, the second setting unit 20D does not use the color difference between the color of the four-wheel vehicle 2B and the color of the traveling road surface of the four-wheel vehicle 2B for setting the second inter-vehicle distance. The reason for this is that the two-wheel vehicle 2A has a smaller color difference from the traveling road surface than the four-wheel vehicle 2B and is less recognizable by the passenger of the own vehicle 1. In addition, the four-wheel vehicle 2B has a wider variation in the color of the vehicle body than the two-wheel vehicle 2A, is likely to have a larger color difference from the traveling road surface than the two-wheel vehicle 2A, and is easily recognizable by the passenger of the own vehicle 1.

In addition, as described above, in response to determining that the environment of the traveling road surface of the own vehicle 1 and the two-wheel vehicle 2A is the predetermined vehicle rollover risk environment, the first setting unit 20C sets the first inter-vehicle distance obtained by changing the first initial inter-vehicle distance to a longer distance. On the other hand, the second setting unit 20D does not use whether or not the environment of the traveling road surface of the four-wheel vehicle 2B is the vehicle rollover risk environment for setting the second inter-vehicle distance. The reason for this is that, since the two-wheel vehicle 2A is more likely to roll over than the four-wheel vehicle 2B, it is preferable to enhance the output sensitivity of the warning information regarding the two-wheel vehicle 2A depending on whether or not the environment of the traveling road surface is the vehicle rollover risk environment. In addition, since the four-wheel vehicle 2B is less affected by the environment of the traveling road surface than the two-wheel vehicle 2A, the necessity for using the environment of the traveling road surface for adjusting the output sensitivity of the warning information regarding of the four-wheel vehicle 2B is low.

In addition, as described above, when the steering angle of the own vehicle 1 is the predetermined angle or more, the first setting unit 20C sets the first inter-vehicle distance obtained by changing the first initial inter-vehicle distance to a farther distance. On the other hand, the second setting unit 20D does not use the steering angle of the own vehicle 1 for setting the second inter-vehicle distance to the four-wheel vehicle 2B. When the own vehicle 1 turns left or right or is traveling in a curved road, the possibility of occurrence of an accident involving the two-wheel vehicle 2A is higher than that of the four-wheel vehicle 2B. Therefore, with regard to the two-wheel vehicle 2A, it is necessary to enhance the output sensitivity of the warning information regarding the two-wheel vehicle 2A in accordance with the steering angle of the own vehicle 1. When the own vehicle 1 turns left or right or is traveling in a curved road, the possibility of occurrence of an accident involving the four-wheel vehicle 2B is lower than that of the two-wheel vehicle 2A. Therefore, with regard to the four-wheel vehicle 2B, it is necessary to change the output sensitivity of the warning information regarding the four-wheel vehicle 2B in accordance with the steering angle of the own vehicle 1.

In addition, as described above, when the information representing the situation of the acceleration and deceleration of the own vehicle 1 represents the deceleration of the own vehicle 1, the first setting unit 20C sets the first inter-vehicle distance obtained by changing the first initial inter-vehicle distance to a farther distance. On the other hand, the first setting unit 20C does not use the deceleration of the own vehicle 1 for setting the second inter-vehicle distance. The reason for this is that, since the two-wheel vehicle 2A has a longer braking distance than the four-wheel vehicle 2B, the output sensitivity of the warning information regarding the two-wheel vehicle 2A needs to be enhanced during the deceleration of the own vehicle 1. In addition, since the four-wheel vehicle 2B has a shorter braking distance than the two-wheel vehicle 2A, the necessity for enhancing the output sensitivity of the warning information regarding the four-wheel vehicle 2B during the deceleration of the own vehicle 1 is low.

In addition, as described above, in response to determining that the operation of the passenger of the two-wheel vehicle 2A is the predetermined operation, the first setting unit 20C sets the first inter-vehicle distance obtained by changing the first initial inter-vehicle distance to a farther distance. On the other hand, the second setting unit 20D does not use the operation of the passenger of the four-wheel vehicle 2B for setting the second inter-vehicle distance. The reason for this is that the operation of the passenger of the two-wheel vehicle 2A is highly likely to be executed for some kind of communication with another external vehicle such as the own vehicle 1. On the other hand, the operation of the passenger of the four-wheel vehicle 2B is not likely to be executed for some kind of communication with another external vehicle.

Next, the output control unit 20E will be described.

The output control unit 20E outputs warning information based on an output condition corresponding to the result of the determination by the vehicle determination unit 20A of whether the other vehicle 2 in the captured image is the two-wheel vehicle 2A or the four-wheel vehicle 2B. That is, based on the output condition corresponding to whether the other vehicle 2 in the captured image of the periphery of the own vehicle 1 is the two-wheel vehicle 2A or the four-wheel vehicle 2B, the output control unit 20E outputs warning information regarding the other vehicle 2 to the passenger of the own vehicle 1. The warning information only needs to be information capable of giving the passenger a heads-up about the presence of the other vehicle 2.

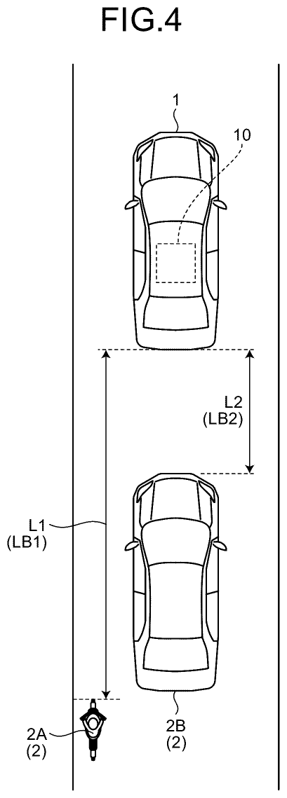

FIG. 4 is a schematic diagram illustrating an example of a positional relationship between the own vehicle 1 and the other vehicle 2 when the output control unit 20E outputs the warning information.

When the inter-vehicle distance between the two-wheel vehicle 2A determined by the vehicle determination unit 20A and the own vehicle 1 is the first inter-vehicle distance L1 or less, the output control unit 20E outputs the warning information. Specifically, when the inter-vehicle distance between the two-wheel vehicle 2A determined by the vehicle determination unit 20A and the own vehicle 1 is the first inter-vehicle distance L1 or less, the output control unit 20E outputs the warning information regarding the two-wheel vehicle 2A to the passenger of the own vehicle 1.

In addition, when the inter-vehicle distance between the four-wheel vehicle 2B determined by the vehicle determination unit 20A and the own vehicle 1 is the second inter-vehicle distance L2 or less, the output control unit 20E outputs the warning information. Specifically, when the inter-vehicle distance between the four-wheel vehicle 2B determined by the vehicle determination unit 20A and the own vehicle 1 is the second inter-vehicle distance L2 or less, the output control unit 20E outputs the warning information regarding the four-wheel vehicle 2B to the passenger of the own vehicle 1.

As described above, the first inter-vehicle distance L1 is a distance that is changed from the first initial inter-vehicle distance LB1 in accordance with the first traveling situation information, and the second inter-vehicle distance L2 is a distance that is changed from the second initial inter-vehicle distance LB2 in accordance with the second traveling situation information. In addition, the first initial inter-vehicle distance LB1 is a distance longer than the second initial inter-vehicle distance LB2 (the first initial inter-vehicle distance LB1>the second initial inter-vehicle distance LB2). The first inter-vehicle distance L1 and the second inter-vehicle distance L2 that are changed from the first initial inter-vehicle distance LB1 and the second initial inter-vehicle distance LB2, respectively, may eventually satisfy a relationship of the first inter-vehicle distance L1≤the second inter-vehicle distance L2 in accordance with the first traveling situation information and the second traveling situation information of the other vehicles 2, respectively.

That is, the output control unit 20E adjusts an output timing of the warning information regarding each of the two-wheel vehicle 2A and the four-wheel vehicle 2B using the first inter-vehicle distance or the second inter-vehicle distance that is set depending on whether the other vehicle 2 in the captured image is the two-wheel vehicle 2A or the four-wheel vehicle 2B. Through these processes, the output control unit 20E outputs the warning information based on the output condition corresponding to the result of the determination of whether the other vehicle 2 is the two-wheel vehicle 2A or the four-wheel vehicle 2B.

By reading the relative traveling situation information derived by the traveling situation derivation unit 20B, the output control unit 20E may determine each of the inter-vehicle distance between the own vehicle 1 and the two-wheel vehicle 2A and the inter-vehicle distance between the own vehicle 1 and the four-wheel vehicle 2B to use the determination result for determining the output of the warning information.

In addition, when the other vehicle 2 determined by the vehicle determination unit 20A is the two-wheel vehicle 2A and the two-wheel vehicle 2A moves away from the own vehicle 1, it is preferable that the output control unit 20E excludes the two-wheel vehicle 2A from an output target of the warning information. The output control unit 20E may determine whether or not the two-wheel vehicle 2A moves away from the own vehicle 1 by reading information representing whether the other vehicle 2 moves away from or approaches the own vehicle 1 included in the relative traveling situation information derived by the vehicle determination unit 20A. In this case, even when the inter-vehicle distance between the two-wheel vehicle 2A and the own vehicle 1 is the first inter-vehicle distance or less, in a case where the two-wheel vehicle 2A travels in a direction away from the own vehicle 1, the output control unit 20E can avoid outputting the warning information regarding the two-wheel vehicle 2A. In addition, in a case where the own vehicle 1 increases the speed such that the distance between the own vehicle 1 and the two-wheel vehicle 2A increases, even when the inter-vehicle distance between the two-wheel vehicle 2A and the own vehicle 1 is the first inter-vehicle distance or less, the output control unit 20E can avoid outputting the warning information regarding the two-wheel vehicle 2A. In addition, in a state where any one of the own vehicle 1 and the two-wheel vehicle 2A is stopped and the other one travels such that the other vehicle 2 moves away from the own vehicle 1, even when the inter-vehicle distance between the own vehicle 1 and the two-wheel vehicle 2A is the first inter-vehicle distance or less, the output control unit 20E can avoid outputting the warning information regarding the two-wheel vehicle 2A.

In addition, when the other vehicle 2 determined by the vehicle determination unit 20A is the four-wheel vehicle 2B and the vehicle speed of the own vehicle 1 in the second traveling situation information derived by the traveling situation derivation unit 20B is lower than the predetermined speed, it is preferable that the output control unit 20E disables the output of the warning information regarding the four-wheel vehicle 2B. The predetermined speed may be previously set in response to the operation instruction or the like of the operation unit 17 by the user and previously stored in the storage unit 19. In addition, the predetermined speed can be changed in response to the operation instruction or the like of the operation unit 17 by the user.

Unlike the two-wheel vehicle 2A, the four-wheel vehicle 2B is not likely to travel after passing the periphery of the own vehicle 1. Therefore, when the speed of the own vehicle 1 is lower than the predetermined speed due to congestion, waiting for a traffic light, or the like, it is preferable to disable the output of the warning information. Through this process, inconvenience to the passenger of the own vehicle 1 caused by frequent output of the warning information or continuous output of the warning information in a predetermined period or longer can be suppressed. On the other hand, the two-wheel vehicle 2A is highly likely to travel after passing the periphery of the own vehicle 1. Therefore, even when the speed of the own vehicle 1 is lower than the predetermined speed, it is preferable to enable the output of the warning information without disabling the output of the warning information. Through this process, even when the speed of the own vehicle 1 is low, in a case where the inter-vehicle distance to the two-wheel vehicle 2A that is traveling after passing the periphery of the own vehicle 1 is the first inter-vehicle distance or less, the warning information can be output.

In addition, when the other vehicle 2 determined by the vehicle determination unit 20A is the four-wheel vehicle 2B and the four-wheel vehicle 2B moves away from the own vehicle 1, it is preferable that the output control unit 20E excludes the four-wheel vehicle 2B from an output target of the warning information. The output control unit 20E may determine whether or not the four-wheel vehicle 2B moves away from the own vehicle 1 by reading information representing whether the other vehicle 2 moves away from or approaches the own vehicle 1 included in the relative traveling situation information derived by the vehicle determination unit 20A. In this case, even when the inter-vehicle distance between the four-wheel vehicle 2B and the own vehicle 1 is the second inter-vehicle distance or less, in a case where the four-wheel vehicle 2B moves away from the own vehicle 1, the output control unit 20E can avoid outputting the warning information regarding the four-wheel vehicle 2B.

In addition, when the other vehicle 2 determined by the vehicle determination unit 20A is the four-wheel vehicle 2B and a relative speed between the own vehicle 1 and the four-wheel vehicle 2B is a predetermined relative speed or higher, it is preferable that the output control unit 20E outputs the warning information regarding the four-wheel vehicle 2B. In addition, in a case where the other vehicle 2 determined by the vehicle determination unit 20A is the four-wheel vehicle 2B and the relative speed between the own vehicle 1 and the four-wheel vehicle 2B is lower than the predetermined relative speed, even when the inter-vehicle distance between the own vehicle 1 and the four-wheel vehicle 2B is the first inter-vehicle distance or less, it is preferable that the output control unit 20E excludes the four-wheel vehicle 2B from an output target of the warning information.

The predetermined relative speed may be previously set in response to the operation instruction or the like of the operation unit 17 by the user and previously stored in the storage unit 19. As the predetermined relative speed, for example, a relative speed that is a threshold for determining whether or not the degree of danger increases may be preset. The predetermined relative speed is, for example, 40 km per hour but is not limited to this value. In addition, the predetermined relative speed can be changed in response to the operation instruction or the like of the operation unit 17 by the user.

Even when the inter-vehicle distance between the own vehicle 1 and the four-wheel vehicle 2B is the second inter-vehicle distance or less, in a case where the relative speed between the own vehicle 1 and the four-wheel vehicle 2B is lower than the predetermined relative speed, by outputting the warning information regarding the four-wheel vehicle 2B, the output control unit 20E can suppress the output of the warning information regarding the four-wheel vehicle 2B in a situation where the degree of danger of the own vehicle 1 to the four-wheel vehicle 2B is low.

This way, when the other vehicle 2 determined by the vehicle determination unit 20A is the four-wheel vehicle 2B and a relative speed between the own vehicle 1 and the four-wheel vehicle 2B is a predetermined relative speed or higher, the output control unit 20E outputs the warning information regarding the four-wheel vehicle 2B. On the other hand, when the other vehicle 2 determined by the vehicle determination unit 20A is the two-wheel vehicle 2A, in a case where the inter-vehicle distance is the first inter-vehicle distance or less and the two-wheel vehicle 2A does not move away from the own vehicle 1, the output control unit 20E outputs the warning information regarding the two-wheel vehicle 2A irrespective of the magnitude of the relative speed between the own vehicle 1 and the two-wheel vehicle 2A. The reason for this is that, since the two-wheel vehicle 2A has a smaller size than the four-wheel vehicle 2B and is less recognizable by the passenger of the own vehicle 1, it is preferable to output the warning information regarding the two-wheel vehicle 2A irrespective of the magnitude of the relative speed. On the other hand, since the four-wheel vehicle 2B has a larger size than the two-wheel vehicle 2A and is easily recognizable by the passenger of the own vehicle 1, it is preferable to output the warning information regarding the four-wheel vehicle 2B when the relative speed is the predetermined relative speed or higher.

In addition, in a case where the other vehicle 2 determined by the vehicle determination unit 20A is the four-wheel vehicle 2B and a first lane on which the own vehicle 1 travels and a second lane on which the four-wheel vehicle 2B travels match with each other, it is preferable that the output control unit 20E outputs the warning information when the inter-vehicle distance to the four-wheel vehicle 2B is the second inter-vehicle distance or less.

The first lane is a lane on which the own vehicle 1 is traveling. The second lane is a lane on which the four-wheel vehicle 2B is traveling. The output control unit 20E determines the first lane on which the own vehicle 1 travels and the second lane on which the four-wheel vehicle 2B travels by reading the lane on which each of the own vehicle 1 and the other vehicle 2 travels in the relative traveling situation information derived by the traveling situation derivation unit 20B. In a case where the first lane on which the own vehicle 1 travels and the second lane on which the other vehicle 2 travels are the same, the output control unit 20E may output the warning information when the inter-vehicle distance to the four-wheel vehicle 2B is the second inter-vehicle distance or less.

When the four-wheel vehicle 2B is traveling in a lane different from that of the own vehicle 1, the degree of danger of the own vehicle 1 to the traveling of the four-wheel vehicle 2B is low. Therefore, in a case where the other vehicle 2 determined by the vehicle determination unit 20A is the four-wheel vehicle 2B and a first lane on which the own vehicle 1 travels and a second lane on which the four-wheel vehicle 2B travels match with each other, by outputting the warning information when the inter-vehicle distance to the four-wheel vehicle 2B is the second inter-vehicle distance or less, the output control unit 20E can output the warning information corresponding to the relative traveling situation between the own vehicle 1 and the four-wheel vehicle 2B.

In addition, in a case where the other vehicle 2 determined by the vehicle determination unit 20A is the four-wheel vehicle 2B, the first lane on which the own vehicle 1 travels and the second lane on which the four-wheel vehicle 2B travels do not match with each other, and a lane present in a planned traveling change direction of the own vehicle 1 and the second lane match with each other, it is preferable that the output control unit 20E outputs the warning information when the inter-vehicle distance to the four-wheel vehicle 2B is the second inter-vehicle distance or less. The output control unit 20E reads the lane on which each of the own vehicle 1 and the other vehicle 2 is traveling and another lane that is a lane around the own vehicle 1 and where the own vehicle 1 is allowed to travel in the same direction as the traveling direction of the current traveling in the relative traveling situation information. In addition, the output control unit 20E determines the planned traveling change direction of the own vehicle 1 represented by the direction indicator in the operation unit 17. In a case where the other lane present in the determined planned traveling change direction matches with the second lane, the output control unit 20E outputs the warning information when the inter-vehicle distance to the four-wheel vehicle 2B is the second inter-vehicle distance or less.

Through these processes, when the inter-vehicle distance to the four-wheel vehicle 2B that is present in the lane of the planned traveling change direction of the own vehicle 1 represented by the operation of the direction indicator of the passenger is the second inter-vehicle distance or less, the output control unit 20E can output the warning information regarding the four-wheel vehicle 2B to the passenger of the own vehicle 1.

This way, in a case where the other vehicle 2 determined by the vehicle determination unit 20A is the four-wheel vehicle 2B and a first lane on which the own vehicle 1 travels and a second lane on which the four-wheel vehicle 2B travels match with each other, the output control unit 20E outputs the warning information when the inter-vehicle distance to the four-wheel vehicle 2B is the second inter-vehicle distance or less. On the other hand, in a case where the other vehicle 2 is the two-wheel vehicle 2A, when the inter-vehicle distance is determined to be the first inter-vehicle distance or less and the two-wheel vehicle 2A does not move away from the own vehicle 1, the output control unit 20E outputs the warning information regarding the two-wheel vehicle 2A irrespective of the lane of the two-wheel vehicle 2A. The reason for this is as follows. For example, even when the two-wheel vehicle 2A is traveling in a lane different from that of the own vehicle 1, the two-wheel vehicle 2A is likely to travel after passing the periphery of the own vehicle 1. Therefore, it is preferable that the warning information regarding the two-wheel vehicle 2A is output irrespective of whether or not the lanes match with each other. On the other hand, the four-wheel vehicle 2B is not likely to travel after passing the periphery of the own vehicle 1. Therefore, it is preferable to output the warning information regarding the four-wheel vehicle 2B when the four-wheel vehicle 2B travels in the lane that matches with that of the own vehicle 1.

In addition, in a case where the other vehicle 2 is the four-wheel vehicle 2B, the first lane on which the own vehicle 1 travels and the second lane on which the four-wheel vehicle 2B travels do not match with each other, and a lane present in a planned traveling change direction of the own vehicle 1 and the second lane match with each other, the output control unit 20E outputs the warning information when the inter-vehicle distance to the four-wheel vehicle 2B is the second inter-vehicle distance or less. On the other hand, in a case where the other vehicle 2 is the two-wheel vehicle 2A, when the inter-vehicle distance is determined to be the first inter-vehicle distance or less and the two-wheel vehicle 2A does not move away from the own vehicle 1, the output control unit 20E outputs the warning information regarding the two-wheel vehicle 2A irrespective of whether or not the lane present in the planned traveling change direction of the own vehicle 1 and the lane on which the two-wheel vehicle 2A is traveling match with each other. The reason for this is as follows. For example, irrespective of whether or not the two-wheel vehicle 2A is traveling in the lane present in the planned traveling change direction of the own vehicle 1, the two-wheel vehicle 2A is likely to travel after passing the periphery of the own vehicle 1. Therefore, it is preferable that the warning information regarding the two-wheel vehicle 2A is output irrespective of the lane. On the other hand, the four-wheel vehicle 2B is not likely to travel after passing the periphery of the own vehicle 1. Therefore, it is preferable to output the warning information regarding the four-wheel vehicle 2B when the four-wheel vehicle 2B is likely to travel in the lane that matches with that of the own vehicle 1. In addition, by setting the four-wheel vehicle 2B that is traveling in the lane matching with the lane present in the planned traveling change direction of the own vehicle 1 to an output target of the warning information, constant output of warning information regarding another four-wheel vehicle 2B that is traveling in a lane different from the planned traveling change direction of the own vehicle 1 is suppressed.

In the present embodiment, the output control unit 20E outputs the warning information regarding the other vehicle 2 to the passenger of the own vehicle 1. For example, the output control unit 20E outputs the warning information to at least one of the display unit 18A and the side mirror 18B.

In the present embodiment, a form where the output control unit 20E outputs the warning information to the display unit 18A that is the electron mirror provided in the own vehicle 1 will be described as an example. The output control unit 20E outputting the warning information to the display unit 18A represents that the output control unit 20E controls the display unit 18A such that the display unit 18A displays the warning information. The output control unit 20E may further output the warning information to a speaker in the meter computer 18. The output control unit 20E outputting the warning information to the speaker represents that the output control unit 20E controls the speaker such that the speaker outputs a sound representing the warning information. In addition, the output control unit 20E may output the warning information to the indicator of the side mirror 18B.

For example, the output control unit 20E outputs the warning information by superimposing and displaying an image highlighting the region such as a frame image in a region where the other vehicle 2 is imaged in the captured image acquired by the imaging device 13.

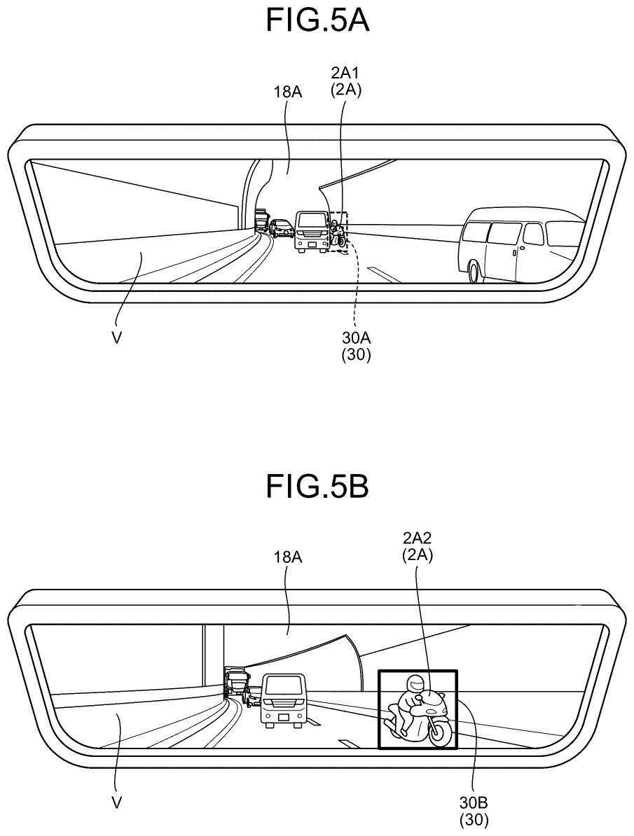

FIGS. 5A and 5B are schematic diagrams illustrating examples of warning information 30 regarding the two-wheel vehicle 2A displayed on the display unit 18A.

FIG. 5A is a schematic diagram illustrating an example of warning information 30A regarding a two-wheel vehicle 2A1 displayed on the display unit 18A. The two-wheel vehicle 2A1 is an example of the two-wheel vehicle 2A. The warning information 30A is an example of the warning information 30.

For example, a case where the vehicle determination unit 20A determines the two-wheel vehicle 2A1 in a captured image V is assumed. The two-wheel vehicle 2A1 is an example of the two-wheel vehicle 2A. A scene where the first setting unit 20C sets a first inter-vehicle distance L1a based on the first traveling situation information regarding the two-wheel vehicle 2A1 is assumed. The first inter-vehicle distance L1a is an example of the first inter-vehicle distance L1. In this case, when the inter-vehicle distance between the own vehicle 1 and the two-wheel vehicle 2A1 is the first inter-vehicle distance L1a or less, the output control unit 20E outputs the warning information 30A to the display unit 18A. FIG. 5A illustrates a form where the warning information 30A is a frame image surrounding the two-wheel vehicle 2A1 in the captured image V as an example.

FIG. 5B is a schematic diagram illustrating an example of warning information 30B regarding a two-wheel vehicle 2A2 displayed on the display unit 18A. The two-wheel vehicle 2A2 is an example of the two-wheel vehicle 2A. The warning information 30B is an example of the warning information 30.

For example, a case where the vehicle determination unit 20A determines the two-wheel vehicle 2A2 in the captured image V is assumed. A scene where the first setting unit 20C sets a first inter-vehicle distance L1b based on the first traveling situation information regarding the two-wheel vehicle 2A2 is assumed. In addition, a scene where the first inter-vehicle distance L1b is shorter than the above-described first inter-vehicle distance L1a is assumed. In this case, when the inter-vehicle distance between the own vehicle 1 and the two-wheel vehicle 2A2 is the first inter-vehicle distance L1b or less, the output control unit 20E outputs the warning information 30B to the display unit 18A. FIG. 5B illustrates a form where the warning information 30B is a frame image surrounding the two-wheel vehicle 2A2 in the captured image V as an example.

In addition, the output control unit 20E may output the warning information 30 in an output form for calling more attention of the passenger as the set first inter-vehicle distance L1 decreases. For example, as compared to the warning information 30A regarding the two-wheel vehicle 2A1 present at an inter-vehicle distance that is less than or equal to the first inter-vehicle distance L1a illustrated in FIG. 5A, the output control unit 20E outputs the warning information 30B regarding the two-wheel vehicle 2A2 present at an inter-vehicle distance that is less than or equal to the first inter-vehicle distance L1b shorter than the first inter-vehicle distance L1a in an output form for calling more attention. FIGS. 5A and 5B illustrate the forms where the warning information 30A is a frame image of a dotted line and the warning information 30B is a frame image of a solid line as the examples.

In addition, when the two-wheel vehicle 2A determined by the vehicle determination unit 20A breaks into the range of the inter-vehicle distance of the first inter-vehicle distance L1 or less, the output control unit 20E may output the warning information 30 in an output form for calling more attention of the passenger of the own vehicle 1 as the inter-vehicle distance to the two-wheel vehicle 2A decreases.

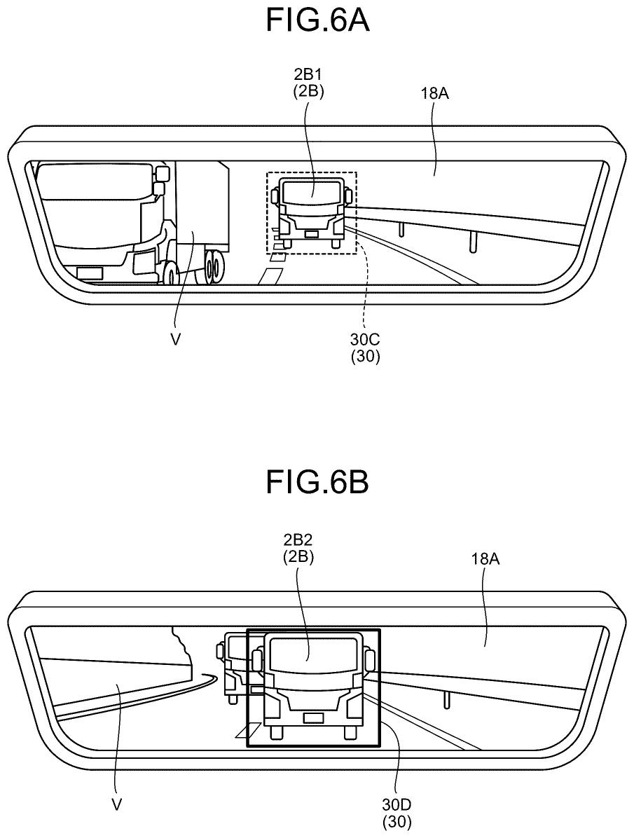

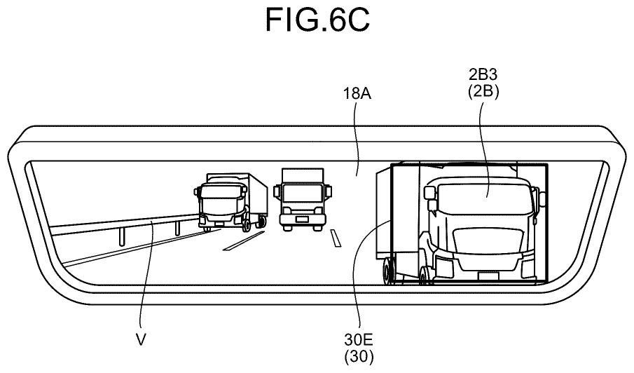

FIGS. 6A to 6C are schematic diagrams illustrating examples of the warning information 30 regarding the four-wheel vehicle 2B displayed on the display unit 18A.

FIG. 6A is a schematic diagram illustrating an example of warning information 30C regarding a four-wheel vehicle 2B1 displayed on the display unit 18A. The four-wheel vehicle 2B1 is an example of the four-wheel vehicle 2B. The warning information 30C is an example of the warning information 30.

For example, a case where the vehicle determination unit 20A determines the four-wheel vehicle 2B1 in the captured image V is assumed. The four-wheel vehicle 2B1 is an example of the four-wheel vehicle 2B. A scene where the second setting unit 20D sets a second inter-vehicle distance L2a based on the second traveling situation information regarding the four-wheel vehicle 2B1 is assumed. The second inter-vehicle distance L2a is an example of the second inter-vehicle distance L2. In this case, when the inter-vehicle distance between the own vehicle 1 and the four-wheel vehicle 2B1 is the second inter-vehicle distance L2a or less, the output control unit 20E outputs the warning information 30C to the display unit 18A. FIG. 5A illustrates a form where the warning information 30C is a frame image surrounding the four-wheel vehicle 2B1 in the captured image V as an example.

FIG. 6B is a schematic diagram illustrating an example of warning information 30D regarding a four-wheel vehicle 2B2 displayed on the display unit 18A. The four-wheel vehicle 2B2 is an example of the four-wheel vehicle 2B. The warning information 30D is an example of the warning information 30.

For example, a case where the vehicle determination unit 20A determines the four-wheel vehicle 2B2 in the captured image V is assumed. A scene where the second setting unit 20D sets a second inter-vehicle distance L2b based on the second traveling situation information regarding the four-wheel vehicle 2B2 is assumed. In addition, a scene where the second inter-vehicle distance L2b is shorter than the above-described second inter-vehicle distance L2a is assumed. In this case, when the inter-vehicle distance between the own vehicle 1 and the four-wheel vehicle 2B2 is the second inter-vehicle distance L2b or less, the output control unit 20E outputs the warning information 30D to the display unit 18A. FIG. 6B illustrates a form where the warning information 30D is a frame image surrounding the four-wheel vehicle 2B2 in the captured image V as an example. In addition, the output control unit 20E may output the warning information 30 in an output form for calling more attention of the passenger as the set second inter-vehicle distance L2 decreases. For example, as compared to the warning information 30C regarding the four-wheel vehicle 2B1 present at an inter-vehicle distance that is less than or equal to the second inter-vehicle distance L2a illustrated in FIG. 6A, the output control unit 20E outputs the warning information 30D regarding the four-wheel vehicle 2B2 present at an inter-vehicle distance that is less than or equal to the second inter-vehicle distance L2b shorter than the second inter-vehicle distance L2a in an output form for calling more attention. FIGS. 6A and 6B illustrate the forms where the warning information 30C is a frame image of a dotted line and the warning information 30D is a frame image of a solid line as the examples.

In addition, when the four-wheel vehicle 2B determined by the vehicle determination unit 20A breaks into the range of the inter-vehicle distance of the second inter-vehicle distance L2 or less, the output control unit 20E may output the warning information 30 in an output form for calling more attention of the passenger of the own vehicle 1 as the inter-vehicle distance to the four-wheel vehicle 2B decreases.

FIG. 6C is a schematic diagram illustrating an example of warning information 30E regarding a four-wheel vehicle 2B3 displayed on the display unit 18A. The four-wheel vehicle 2B3 is an example of the four-wheel vehicle 2B. The warning information 30E is an example of the warning information 30.

For example, a case where the vehicle determination unit 20A determines the four-wheel vehicle 2B3 in the captured image V is assumed. A scene where the second setting unit 20D sets a second inter-vehicle distance L2c based on the second traveling situation information regarding the four-wheel vehicle 2B3 is assumed. A case where the first lane on which the own vehicle 1 travels and the second lane on which the four-wheel vehicle 2B3 travels are different from each other is assumed. In this case, in a case where the direction indicator of the own vehicle 1 is operated by the driver and the lane present in the planned traveling change direction of the own vehicle 1 and the second lane of the four-wheel vehicle 2B3 match with each other, the output control unit 20E outputs warning information 30E when the inter-vehicle distance to the four-wheel vehicle 2B3 is the second inter-vehicle distance L2c or less. FIG. 6C illustrates a form where a frame image surrounding the four-wheel vehicle 2B3 in the captured image V is output as the warning information 30E as an example.

By checking the output warning information 30, the passenger of the own vehicle 1 can recognize the presence of the other vehicle 2 around the own vehicle 1.

There is a case where the vehicle determination unit 20A determines a plurality of two-wheel vehicles 2A in the captured image at the same timing. For example, when the two-wheel vehicles 2A travel in a row on the rear side of the own vehicle 1, the two-wheel vehicles 2A are imaged in the captured image, and the vehicle determination unit 20A determines the two-wheel vehicles 2A. In this case, the two-wheel vehicle 2A having different inter-vehicle distances to the own vehicle 1 are in a state of being present on the rear side of the own vehicle 1, and the two-wheel vehicles 2A are positioned at relative positions that are respectively set to be the first inter-vehicle distance or less. As a result, the output control unit 20E outputs a plurality of pieces of the warning information 30 regarding the plurality of two-wheel vehicle 2A continuously or in a period where some of the output timings overlap each other.

Therefore, when the number of the two-wheel vehicles 2A that are determined to be imaged in the captured image by the vehicle determination unit 20A is a predetermined number or more, it is preferable that the output control unit 20E outputs the plurality of pieces of warning information 30 regarding the two-wheel vehicles 2A at a predetermined period interval. The predetermined number and the predetermined period interval may be previously set in response to the operation instruction or the like of the operation unit 17 by the user and previously stored in the storage unit 19. In addition, the predetermined number and the predetermined period interval can be appropriately changed in response to the operation instruction or the like of the operation unit 17 by the user. On the other hand, the output control unit 20E does not need to use the number of the four-wheel vehicles 2B in the captured image for adjusting the output interval of the warning information 30. The reason for this is that the plurality of four-wheel vehicles 2B are not likely to continuously travel after passing the periphery of the own vehicle 1.

In addition, the output control unit 20E may provide a maximum value for the number of the warning information 30 regarding the plurality of other vehicles 2 output at the same timing. In this case, among the two-wheel vehicles 2A and the four-wheel vehicles 2B determined by the vehicle determination unit 20A, the output control unit 20E may execute the above-described process regarding each of the other vehicles 2 corresponding to the number of the maximum value in order from the other vehicle 2 having the shortest inter-vehicle distance to the own vehicle 1 to output the warning information 30 regarding the other vehicle 2. In addition, the output control unit 20E may provide a first maximum value that is the number of pieces of the warning information 30 regarding the plurality of two-wheel vehicles 2A output at the same timing and a second maximum value that is the number of pieces of the warning information 30 regarding the plurality of four-wheel vehicles 2B output at the same timing. In this case, it is preferable that the first maximum value is more than the second maximum value.

Next, an example of a procedure of information processing that is executed by the information processing device 10 according to the present embodiment will be described.

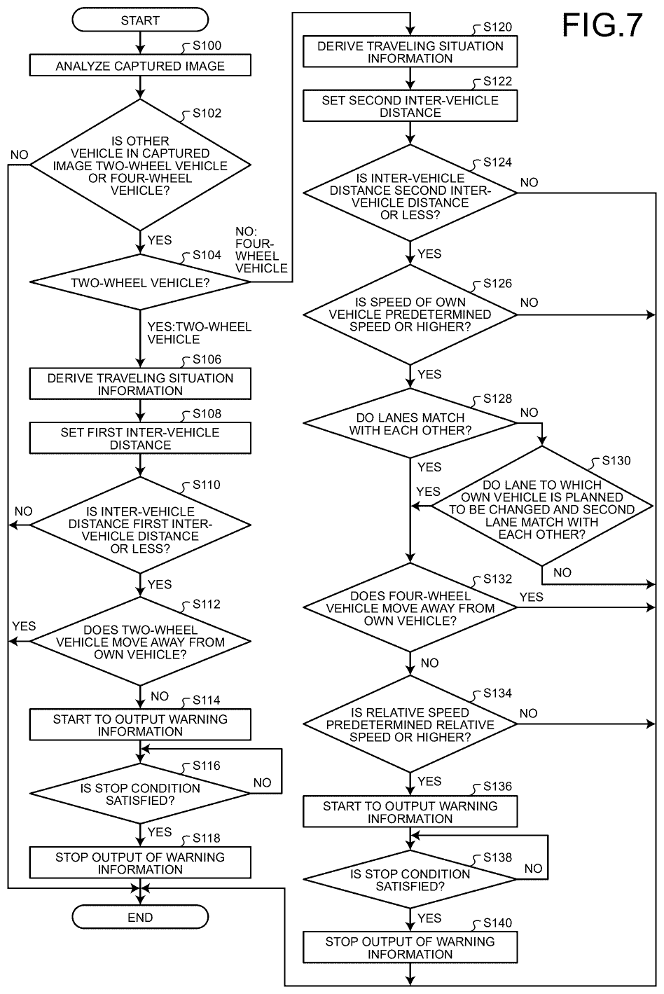

FIG. 7 is a flowchart illustrating an example of the procedure of information processing that is executed by the information processing device 10 according to the present embodiment.

The vehicle determination unit 20A analyzes the captured image of the periphery of the own vehicle acquired by the imaging device 13 (Step S100). The vehicle determination unit 20A determines whether the other vehicle 2 in the captured image is the two-wheel vehicle 2A or the four-wheel vehicle 2B (Step S102). When the other vehicle 2 in the captured image is neither the two-wheel vehicle 2A nor the four-wheel vehicle 2B (Step S102: No), the present routine ends. When the other vehicle 2 in the captured image is the two-wheel vehicle 2A or the four-wheel vehicle 2B, the processing unit 20 executes the processes of Step S104 to Step S140 on each of the two-wheel vehicles 2A and the four-wheel vehicles 2B in the captured image.

When the other vehicle 2 in the captured image is the two-wheel vehicle 2A (Step S104: Yes), the process proceeds to Step S106. In Step S106, the traveling situation derivation unit 20B derives the traveling situation information including the first traveling situation information and the relative traveling situation information regarding a traveling situation of at least one of the own vehicle 1 and the determined two-wheel vehicle 2A (Step S106).

The first setting unit 20C sets the first inter-vehicle distance that is changed from the first initial inter-vehicle distance in accordance with the first traveling situation information in the traveling situation information derived in Step S106 (Step S108).

The output control unit 20E determines whether or not the inter-vehicle distance between the two-wheel vehicle 2A determined in Step S102 and the own vehicle 1 is less than or equal to the first inter-vehicle distance set in Step S108 (Step S110). When No is determined in Step S110 (Step S110: No), the present routine ends. When Yes is determined in Step S110 (Step S110: Yes), the process proceeds to Step S112.

In Step S112, the output control unit 20E determines whether or not the two-wheel vehicle 2A determined in Step S102 moves away from the own vehicle 1 (Step S112). The output control unit 20E determines whether or not the two-wheel vehicle 2A moves away from the own vehicle 1 by reading information representing whether the two-wheel vehicle 2A moves away from or approaches the own vehicle 1 in the relative traveling situation information of the traveling situation information derived in Step S106. In response to determining that the two-wheel vehicle 2A moves away from the own vehicle 1 in Step S112 (Step S112: Yes), the present routine ends. In response to determining that the two-wheel vehicle 2A does not move away from the own vehicle 1 in Step S112 (Step S112: No), the process proceeds to Step S114.

In Step S114, the output control unit 20E starts to output the warning information 30 regarding the two-wheel vehicle 2A determined in Step S102 (Step S114). For example, the output control unit 20E displays the warning information 30 regarding the two-wheel vehicle 2A on the display unit 18A.

Next, the output control unit 20E repeats to determine No (Step S116: No) until determining that the stop condition for stopping the output of the warning information 30 is satisfied (Step S116: Yes). When Yes is determined in Step S116 (Step S116: Yes), the output control unit 20E proceeds to Step S118. When each of a condition where the inter-vehicle distance to the two-wheel vehicle 2A exceeds the first inter-vehicle distance and a condition where the two-wheel vehicle 2A moves away from the own vehicle 1 is set as the stop condition and at least one of these stop conditions is satisfied, the output control unit 20E may determine Yes in Step S116. In Step S118, the output control unit 20E stops the output of the warning information 30 regarding the two-wheel vehicle 2A determined in Step S102 (Step S118), and ends the present routine.

On the other hand, when the other vehicle 2 in the captured image is the four-wheel vehicle 2B (Step S104: No), the process proceeds to Step S120. In Step S120, the traveling situation derivation unit 20B derives the traveling situation information including the second traveling situation information and the relative traveling situation information regarding a traveling situation of at least one of the own vehicle 1 and the determined four-wheel vehicle 2B (Step S120).

The second setting unit 20D sets the second inter-vehicle distance that is changed from the second initial inter-vehicle distance in accordance with the second traveling situation information in the traveling situation information derived in Step S120 (Step S122).

The output control unit 20E determines whether or not the inter-vehicle distance between the four-wheel vehicle 2B determined in Step S102 and the own vehicle 1 is less than or equal to the second inter-vehicle distance set in Step S122 (Step S124). When No is determined in Step S124 (Step S124: No), the present routine ends. When Yes is determined in Step S124 (Step S124: Yes), the process proceeds to Step S126.

In Step S126, the output control unit 20E determines whether or not the vehicle speed of the own vehicle 1 in the second traveling situation information derived in Step S120 is the predetermined speed or higher (Step S126). In response to determining that the vehicle speed of the own vehicle 1 is lower than the predetermined speed (Step S126: No), the output control unit 20E ends the present routine. In response to determining that the vehicle speed of the own vehicle 1 is the predetermined speed or higher (Step S126: Yes), the output control unit 20E proceeds to Step S128.

In Step S128, the output control unit 20E determines whether or not the second lane on which the four-wheel vehicle 2B determined in Step S102 travels and the first lane on which the own vehicle 1 travels match with each other (Step S128). When Yes is determined in Step S128 (Step S128: Yes), the process proceeds to Step S132 described below. When No is determined in Step S128 (Step S128: No), the process proceeds to Step S130.

In Step S130, the output control unit 20E determines whether or not the lane present in the planned traveling change direction of the own vehicle 1 and the second lane on which the four-wheel vehicle 2B travels match with each other (Step S130). When No is determined in Step S130 (Step S130: No), the present routine ends. When Yes is determined in Step S130 (Step S130: Yes), the process proceeds to Step S132.

In Step S132, the output control unit 20E determines whether or not the four-wheel vehicle 2B determined in Step S102 moves away from the own vehicle 1 (Step S132). The output control unit 20E determines whether or not the four-wheel vehicle 2B moves away from the own vehicle 1 by reading information representing whether the four-wheel vehicle 2B moves away from or approaches the own vehicle 1 in the relative traveling situation information of the traveling situation information derived in Step S120. In response to determining that the four-wheel vehicle 2B moves away from the own vehicle 1 in Step S132 (Step S132: Yes), the present routine ends. In response to determining that the four-wheel vehicle 2B does not move away from the own vehicle 1 in Step S132 (Step S132: No), the process proceeds to Step S134.

In Step S134, the output control unit 20E determines whether or not the relative speed between the four-wheel vehicle 2B determined in Step S102 and the own vehicle 1 is the predetermined relative speed or higher (Step S134). The output control unit 20E makes the determination of Step S134 by reading the relative speed between the own vehicle 1 and the four-wheel vehicle 2B in the relative traveling situation information of the traveling situation information derived in Step S120. When No is determined in Step S134 (Step S134: No), the present routine ends. When Yes is determined in Step S134 (Step S134: Yes), the process proceeds to Step S136.

In Step S136, the output control unit 20E starts to output the warning information 30 regarding the four-wheel vehicle 2B determined in Step S102 (Step S136). For example, the output control unit 20E displays the warning information 30 regarding the four-wheel vehicle 2B on the display unit 18A.

Next, the output control unit 20E repeats to determine No (Step S138: No) until determining that the stop condition for stopping the output of the warning information 30 is satisfied (Step S138: Yes). When Yes is determined in Step S138 (Step S138: Yes), the output control unit 20E proceeds to Step S140. When each of a condition where the inter-vehicle distance to the four-wheel vehicle 2B exceeds the second inter-vehicle distance, a condition where vehicle speed of the own vehicle 1 is lower than the predetermined speed, a condition where the lanes on which the own vehicle 1 and the four-wheel vehicle 2B travel do not match with each other and the lane present in the planned traveling change direction of the own vehicle 1 and the lane on which the four-wheel vehicle 2B travels do not match with other, a condition where the four-wheel vehicle 2B moves away from the own vehicle 1, and a condition where the relative speed between the own vehicle 1 and the four-wheel vehicle 2B is lower than the predetermined speed is set as the stop condition and at least one of these stop conditions is satisfied, the output control unit 20E may determine Yes in Step S138. In Step S140, the output control unit 20E stops the output of the warning information 30 regarding the four-wheel vehicle 2B determined in Step S102 (Step S140), and ends the present routine.

As described above, the information processing device 10 according to the present embodiment includes the vehicle determination unit 20A and the output control unit 20E. The vehicle determination unit 20A determines whether the other vehicle 2 in the captured image of the periphery of the own vehicle 1 is the two-wheel vehicle 2A or the four-wheel vehicle 2B. The output control unit 20E outputs warning information based on an output condition corresponding to a result of the determination.

In the related art, there is a case where warning information may be output even in a situation where warning is unnecessary, and there is a case where appropriate warning information corresponding to the other vehicle 2 around the own vehicle 1 may not be output.

On the other hand, based on an output condition corresponding to a result of determination on whether the other vehicle 2 around the own vehicle 1 is a two-wheel vehicle 2A or a four-wheel vehicle 2B, the information processing device 10 according to the present embodiment outputs the warning information. Therefore, in the present embodiment, based on the output condition corresponding to whether the other vehicle 2 around the own vehicle 1 is the two-wheel vehicle 2A or the four-wheel vehicle 2B, the warning information can be output.

Accordingly, the information processing device 10 according to the present embodiment can output the appropriate warning information corresponding to the other vehicle 2 around the own vehicle 1.

In the present embodiment, a form where the information processing device 10 is mounted on the own vehicle 1 has been described as an example. However, the information processing device 10 may be configured to be mounted on a device outside the own vehicle 1. The information processing device 10 may be communicably connected to various electronic devices such as the imaging device 13, the external sensor 14, the internal sensor 15, the traveling control unit 16, the meter computer 18, and the storage unit 19 provided in the own vehicle 1. Therefore, the information processing device 10 may be a form where it is mounted on an information processing device provided outside the own vehicle 1. In this case, the information processing device on which the information processing device 10 is mounted and the above-described various electronic devices may be communicably configured through a network or the like. In addition, in this case, a vehicle that is communicably connected to the information processing device 10 corresponds to the own vehicle 1.

The present disclosure can also adopt the following configurations (1) to (12).

(1) An information processing device comprising:
a memory in which a computer program is stored; and
a processor coupled to the memory and configured to perform processing by executing the computer program, the processing including
   determining whether another vehicle captured in a captured image of a periphery of an own vehicle is a two-wheel vehicle or a four-wheel vehicle, and
   outputting warning information based on an output condition corresponding to a result of the determination.
      (2) The information processing device according to the configuration (1), wherein
the processing further includes setting a first inter-vehicle distance in response to determining that the other vehicle is the two-wheel vehicle, the first inter-vehicle distance being obtained by changing a first initial inter-vehicle distance in accordance with first traveling situation information regarding a traveling situation of at least one of the own vehicle or the two-wheel vehicle, and
the outputting of the warning information is performed when an inter-vehicle distance between the own vehicle and the two-wheel vehicle is the first inter-vehicle distance or less.
   (3) The information processing device according to the configuration (2), wherein the setting of the first inter-vehicle distance is performed by changing the first inter-vehicle distance in accordance with a first condition with which the first traveling situation information matches, the first condition being at least one of conditions including:
a vehicle speed of the own vehicle being a predetermined speed or higher, the number of times of changing a traveling direction of the two-wheel vehicle being a predetermined number of times or more, traveling in a traveling environment at a predetermined illuminance or lower, a driving skill of a driver of the own vehicle being a predetermined level of skill or lower, a driving skill of a driver of the two-wheel vehicle being a predetermined level of skill or lower, an estimated size of the two-wheel vehicle being a predetermined size or less, a color difference between the two-wheel vehicle and a traveling road surface being a predetermined color difference or less, a traveling road of the own vehicle and the two-wheel vehicle being a road where high-speed traveling at a predetermined speed or higher is allowed, an estimated crash severity of the two-wheel vehicle being a predetermined severity or more, a traveling site of the own vehicle and the two-wheel vehicle being in a predetermined warning target region, an environment of a traveling road surface of the own vehicle and the two-wheel vehicle being a predetermined vehicle rollover risk environment, a steering angle of the own vehicle being a predetermined angle or more, deceleration of the own vehicle, a traveling region of the own vehicle and the two-wheel vehicle being in a predetermined area, a vehicle type of the two-wheel vehicle being a preset warning target vehicle, and a predetermined operation by a passenger of the two-wheel vehicle.
   (4) The information processing device according to any one of the configurations (1) to (3), wherein the processing further includes excluding the two-wheel vehicle from an output target of the warning information in response to determining that the other vehicle is the two-wheel vehicle and determining that the two-wheel vehicle moves away from the own vehicle.
   (5) The information processing device according to any one of the configurations (1) to (3), wherein
the processing further includes setting second inter-vehicle distance in response to determining that the other vehicle is the four-wheel vehicle, the second inter-vehicle distance being obtained by changing a second initial inter-vehicle distance in accordance with second traveling situation information regarding a traveling situation of at least one of the own vehicle or the four-wheel vehicle, and
the outputting of the warning information is performed when an inter-vehicle distance between the own vehicle and the four-wheel vehicle is the second inter-vehicle distance or less.
   (6) The information processing device according to the configuration (5), wherein the setting of the second inter-vehicle distance is performed by changing the second inter-vehicle distance in accordance with a second condition with which the second traveling situation information matches, the second condition being at least one of conditions including:
a vehicle speed of the own vehicle being a predetermined speed or higher, an estimated size of the four-wheel vehicle being a predetermined size or more, a traveling road of the own vehicle and the four-wheel vehicle being a road where high-speed traveling at a predetermined speed or higher is allowed and an estimated crash severity of the four-wheel vehicle that is traveling in the road being a predetermined severity or more, the estimated crash severity of the four-wheel vehicle being a predetermined severity or more, a traveling site of the own vehicle and the four-wheel vehicle being in a predetermined warning target region, a vehicle registration number of the four-wheel vehicle being a preset number, a traveling region of the own vehicle and the four-wheel vehicle being in a predetermined area, and a vehicle type of the four-wheel vehicle being a preset warning target vehicle.
   (7) The information processing device according to any one of the configurations (1) to (6), wherein the processing further includes excluding the four-wheel vehicle from an output target of the warning information in response to determining that the other vehicle is the four-wheel vehicle and determining that the four-wheel vehicle moves away from the own vehicle.
   (8) The information processing device according to any one of the configurations (5) to (7), wherein the outputting of the warning information is performed when
the other vehicle is determined to be the four-wheel vehicle,
a relative speed between the own vehicle and the four-wheel vehicle is a predetermined relative speed or higher, and
the inter-vehicle distance between the own vehicle and the four-wheel vehicle is the second inter-vehicle distance or less.
   (9) The information processing device according to any one of the configurations (5) to (8), wherein the outputting of the warning information is performed when
the other vehicle is determined to be the four-wheel vehicle,
a first lane on which the own vehicle travels matches with a second lane on which the four-wheel vehicle travels, and
the inter-vehicle distance between the own vehicle and the four-wheel vehicle is the second inter-vehicle distance or less.
   (10) The information processing device according to any one of the configurations (5) to (9), wherein the outputting of the warning information is performed when
the other vehicle is determined to be the four-wheel vehicle,
a first lane on which the own vehicle travels does not match with a second lane on which the four-wheel vehicle travels,
a lane present in a planned traveling change direction of the own vehicle matches with the second lane, and
the inter-vehicle distance between the own vehicle and the four-wheel vehicle is the second inter-vehicle distance or less.
   (11) An information processing method implemented by a computer, the information processing method comprising:
determining whether another vehicle captured in a captured image of a periphery of an own vehicle is a two-wheel vehicle or a four-wheel vehicle; and
outputting warning information based on an output condition corresponding to a result of the determination.
   (12) A non-transitory computer-readable recording medium on which programmed instructions are recorded, the instructions causing a computer to execute processing, the processing comprising:
determining whether another vehicle captured in a captured image of a periphery of an own vehicle is a two-wheel vehicle or a four-wheel vehicle; and
outputting warning information based on an output condition corresponding to a result of the determination.

While certain embodiments have been described, these embodiments have been presented by way of example only and are not intended to limit the scope of the inventions. Indeed, the novel embodiments described herein can be embodied in a variety of other forms; moreover, various omissions, substitutions and changes can be made without departing from the gist of the inventions. These embodiments or modifications thereof are included in the scope or the gist of the inventions and are included in the inventions described in the claims and an equivalent scope thereof.

What is claimed is:

1. An information processing device comprising:
a memory in which a computer program is stored; and
a processor coupled to the memory and configured to perform processing by executing the computer program, the processing including
determining whether another vehicle captured in a captured image of a periphery of an own vehicle is a two-wheel vehicle or a four-wheel vehicle, and
outputting warning information based on an output condition corresponding to a result of the determination.

2. The information processing device according to claim 1, wherein
the processing further includes setting a first inter-vehicle distance in response to determining that the other vehicle is the two-wheel vehicle, the first inter-vehicle distance being obtained by changing a first initial inter-vehicle distance in accordance with first traveling situation information regarding a traveling situation of at least one of the own vehicle or the two-wheel vehicle, and
the outputting of the warning information is performed when an inter-vehicle distance between the own vehicle and the two-wheel vehicle is the first inter-vehicle distance or less.

3. The information processing device according to claim 2, wherein the setting of the first inter-vehicle distance is performed by changing the first inter-vehicle distance in accordance with a first condition with which the first traveling situation information matches, the first condition being at least one of conditions including:
a vehicle speed of the own vehicle being a predetermined speed or higher, the number of times of changing a traveling direction of the two-wheel vehicle being a predetermined number of times or more, traveling in a traveling environment at a predetermined illuminance or lower, a driving skill of a driver of the own vehicle being a predetermined level of skill or lower, a driving skill of a driver of the two-wheel vehicle being a predetermined level of skill or lower, an estimated size of the two-wheel vehicle being a predetermined size or less, a color difference between the two-wheel vehicle and a traveling road surface being a predetermined color difference or less, a traveling road of the own vehicle and the two-wheel vehicle being a road where high-speed traveling at a predetermined speed or higher is allowed, an estimated crash severity of the two-wheel vehicle being a predetermined severity or more, a traveling site of the own vehicle and the two-wheel vehicle being in a predetermined warning target region, an environment of a traveling road surface of the own vehicle and the two-wheel vehicle being a predetermined vehicle rollover risk environment, a steering angle of the own vehicle being a predetermined angle or more, deceleration of the own vehicle, a traveling region of the own vehicle and the two-wheel vehicle being in a predetermined area, a vehicle type of the two-wheel vehicle being a preset warning target vehicle, and a predetermined operation by a passenger of the two-wheel vehicle.

4. The information processing device according to claim 1, wherein the processing further includes excluding the two-wheel vehicle from an output target of the warning information in response to determining that the other vehicle is the two-wheel vehicle and determining that the two-wheel vehicle moves away from the own vehicle.

5. The information processing device according to claim 1, wherein
the processing further includes setting second inter-vehicle distance in response to determining that the other vehicle is the four-wheel vehicle, the second inter-vehicle distance being obtained by changing a second initial inter-vehicle distance in accordance with second traveling situation information regarding a traveling situation of at least one of the own vehicle or the four-wheel vehicle, and
the outputting of the warning information is performed when an inter-vehicle distance between the own vehicle and the four-wheel vehicle is the second inter-vehicle distance or less.

6. The information processing device according to claim 5, wherein the setting of the second inter-vehicle distance is performed by changing the second inter-vehicle distance in accordance with a second condition with which the second traveling situation information matches, the second condition being at least one of conditions including:
a vehicle speed of the own vehicle being a predetermined speed or higher, an estimated size of the four-wheel vehicle being a predetermined size or more, a traveling road of the own vehicle and the four-wheel vehicle being a road where high-speed traveling at a predetermined speed or higher is allowed and an estimated crash severity of the four-wheel vehicle that is traveling in the road being a predetermined severity or more, the estimated crash severity of the four-wheel vehicle being a predetermined severity or more, a traveling site of the own vehicle and the four-wheel vehicle being in a predetermined warning target region, a vehicle registration number of the four-wheel vehicle being a preset number, a traveling region of the own vehicle and the four-wheel vehicle being in a predetermined area, and a vehicle type of the four-wheel vehicle being a preset warning target vehicle.

7. The information processing device according to claim 1, wherein the processing further includes excluding the four-wheel vehicle from an output target of the warning information in response to determining that the other vehicle is the four-wheel vehicle and determining that the four-wheel vehicle moves away from the own vehicle.

8. The information processing device according to claim 5, wherein the outputting of the warning information is performed when
the other vehicle is determined to be the four-wheel vehicle,
a relative speed between the own vehicle and the four-wheel vehicle is a predetermined relative speed or higher, and
the inter-vehicle distance between the own vehicle and the four-wheel vehicle is the second inter-vehicle distance or less.

9. The information processing device according to claim 5, wherein the outputting of the warning information is performed when
the other vehicle is determined to be the four-wheel vehicle,
a first lane on which the own vehicle travels matches with a second lane on which the four-wheel vehicle travels, and
the inter-vehicle distance between the own vehicle and the four-wheel vehicle is the second inter-vehicle distance or less.

10. The information processing device according to claim 5, wherein the outputting of the warning information is performed when
the other vehicle is determined to be the four-wheel vehicle,
a first lane on which the own vehicle travels does not match with a second lane on which the four-wheel vehicle travels,
a lane present in a planned traveling change direction of the own vehicle matches with the second lane, and
the inter-vehicle distance between the own vehicle and the four-wheel vehicle is the second inter-vehicle distance or less.

11. An information processing method implemented by a computer, the information processing method comprising:
determining whether another vehicle captured in a captured image of a periphery of an own vehicle is a two-wheel vehicle or a four-wheel vehicle; and
outputting warning information based on an output condition corresponding to a result of the determination.

12. A non-transitory computer-readable recording medium on which programmed instructions are recorded, the instructions causing a computer to execute processing, the processing comprising:
determining whether another vehicle captured in a captured image of a periphery of an own vehicle is a two-wheel vehicle or a four-wheel vehicle; and
outputting warning information based on an output condition corresponding to a result of the determination.
